(19) United States
(12) Patent Application Publication
(10) Pub. No.: US 2016/0127016 A1
(43) Pub. Date: May 5, 2016

(54) UPLINK DIVERSITY AND INTERBAND UPLINK CARRIER AGGREGATION IN FRONT-END ARCHITECTURE

(71) Applicant: SKYWORKS SOLUTIONS, INC., Woburn, MA (US)

(72) Inventors: David Richard PEHLKE, Westlake Village, CA (US); Joel Richard KING, Newbury Park, CA (US)

(21) Appl. No.: 14/929,295

(22) Filed: Oct. 31, 2015

Related U.S. Application Data
(60) Provisional application No. 62/073,044, filed on Oct. 31, 2014.

(51) Int. Cl. H04B 7/04; H04B 7/08; H04B 1/40; H04B 7/06

(52) U.S. Cl. CPC H04B 7/0413; H04B 7/06; H04B 7/08; H04B 1/40

(57) ABSTRACT

Uplink diversity and interband uplink carrier aggregation in front-end architecture. In some embodiments, a radio-frequency (RF) front-end architecture can include a first transmit/receive (Tx/Rx) front-end system configured to operate with a first antenna, and a second Tx/Rx front-end system configured to operate with a second antenna. The second Tx/Rx front-end system can be a substantial duplicate of the first Tx/Rx front-end system to provide, for example, uplink (UL) diversity functionality and UL multiple-input-and-multiple-output (MIMO) functionality.

### CROSS-REFERENCE TO RELATED APPLICATION(S)

This application claims priority to U.S. Provisional Application No. 62/073,044 filed Oct. 31, 2014, entitled FRONT-END ARCHITECTURE FOR ENABLING UPLINK DIVERSITY AND INTERBAND UPLINK CARRIER AGGREGATION OPERATION, the disclosure of which is hereby expressly incorporated by reference herein in its respective entirety.

### BACKGROUND

1. Field

The present disclosure relates to front-end architectures for wireless applications.

2. Description of the Related Art

In wireless applications, a downlink (DL) is typically associated with receiving of a radio-frequency (RF) signal by a wireless device, and an uplink is typically associated with transmission of an RF signal by the wireless device. Such DL and UL functionalities are typically provided by a front-end system implemented within the wireless device.

### SUMMARY

According to some implementations, the present disclosure relates to a radio-frequency (RF) front-end architecture that includes a first transmit/receive (Tx/Rx) front-end system configured to operate with a first antenna, and a second Tx/Rx front-end system configured to operate with a second antenna.

In some embodiments, each of the first antenna and the second antenna can be capable of operating as a primary antenna. The second antenna can be an Rx diversity antenna capable of operating as a Tx diversity antenna.

In some embodiments, the RF front-end architecture can be configured to receive a common Tx signal from a transceiver and split the common Tx signal to each of the first and second Tx/Rx front-end systems to provide Tx diversity functionality. The RF front-end architecture can further include a splitter configured to split the common Tx signal into first and second signal paths for the first and second Tx/Rx front-end systems, respectively. The splitter can include, for example, a resistive splitter circuit or a Wilkinson splitter circuit. In some embodiments, each of either or both of the first and second signal paths can include a phase-shifting circuit.

In some embodiments, the RF front-end architecture can be configured to receive a separate Tx signal from a transceiver for each of the first and second Tx/Rx front-end systems. The separate Tx signals from the transceiver can include respective dedicated datastreams such that the RF front-end architecture provides an uplink (UL) multiple-input-and-multiple-output (MIMO) functionality.

In some embodiments, at least one of the first and second Tx/Rx front-end systems can be configured to be capable of operating in an Rx-only mode. The Tx/Rx system with the Rx-only mode capability can include a low-noise amplifier (LNA) coupled to an output of an Rx filter. The Tx/Rx system with the Rx-only mode capability can further include a switchable path implemented to allow bypassing of the LNA.

In some embodiments, the Rx filter can be part of a duplexer. In some embodiments, the Rx filter is a separate filter.

In some embodiments, at least one of the first and second Tx/Rx front-end systems can include a plurality of switch-combined filters configured to provide one or more duplexing functionalities.

In some embodiments, the second Tx/Rx front-end system can be a substantial duplicate of the first Tx/Rx front-end system. The first Tx/Rx front-end system can be implemented in a first uplink (UL)/downlink (DL) module and the second Tx/Rx front-end system can be implemented in a second UL/DL module. The second UL/DL module can be configured to replace a diversity Rx module.

In some embodiments, the first UL/DL module can be part of a first packaged module, and the second UL/DL module can be part of a second packaged module. In some embodiments, both of the first and second UL/DL modules can be parts of a common packaged module.

In some embodiments, the implementation of the second Tx/Rx front-end system can enable antenna switch diversity without a dual-pole antenna switch loss. In some embodiments, the implementation of the second Tx/Rx front-end system can enable Tx uplink diversity by allowing a given signal to be driven by two substantially identical Tx RF chains.

In a number of teachings, the present disclosure relates to a method for performing diversity operations with radio-frequency (RF) signals. The method includes processing transmit (Tx) and receive (Rx) signals with a first Tx/Rx front-end system and a first antenna, and processing Tx and Rx signals with a second Tx/Rx front-end system and a second antenna to provide Tx diversity and Rx diversity through the first and second antennas.

In some implementations, the present disclosure relates to a wireless device that includes a transceiver configured to process RF signals, and a front-end (FE) architecture in communication with the transceiver. The FE architecture includes a first transmit/receive (Tx/Rx) front-end system configured to operate with a first antenna, and a second Tx/Rx front-end system configured to operate with a second antenna.

In some embodiments, the wireless device can be a cellular phone. In some embodiments, the communication between the transceiver and the FE architecture can include a common Tx signal that is split into each of the first and second Tx/Rx front-end systems to provide Tx diversity through the first and second antennas. In some embodiments, the communication between the transceiver and the FE architecture can include a separate Tx signal for each of the first and second Tx/Rx front-end systems to provide an uplink (UL) multiple-input-and-multiple-output (MIMO) functionality for the FE architecture.

In some embodiments, the FE architecture can be implemented substantially within a single packaged module. In some embodiments, the FE architecture can be implemented such that the first Tx/Rx front-end module is implemented in a first packaged module, and the second Tx/Rx front-end module is implemented in a second packaged module.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts a wireless front-end (FE) architecture having one or more features as described herein.

FIG. 2 shows an example of a conventional FE architecture having a downlink (DL) diversity functionality.

FIG. 3 shows that in some embodiments, the FE architecture of FIG. 1 can include an uplink (UL) diversity functionality having one or more features as described herein.

FIG. 4 shows that in some embodiments, the FE architecture of FIG. 3 can be configured to provide UL multiple-input-and-multiple-output (MIMO) functionality.

FIG. 5 shows that in some embodiments, the FE architecture of FIG. 3 can be configured to receive a common transmit (Tx) radio-frequency (RF) signal from a transceiver and process the common Tx RF signal through a plurality of separate modules to provide Tx diversity functionality.

FIG. 6 shows a portion of a more specific example of the FE architecture of FIG. 2.

FIGS. 6A(1), 6A(2), 6A(3), 6A(4), 6A(5) and 6A(6) show more detailed views of FIG. 6.

FIG. 7A shows a portion of the FE architecture of FIGS. 2 and 6.

FIG. 7B shows a portion of the FE architecture of FIGS. 2, 6 and 7A.

FIGS. 7B(1), 7B(2), 7B(3) and 7B(4) show more detailed views of FIG. 7B.

FIG. 8 show a portion of a more specific example of the FE architecture of FIG. 4.

FIGS. 8(1), 8(2), 8(3), 8(4), 8(5), 8(6), 8(7) and 8(8) show more detailed views of FIG. 8.

FIG. 9A shows a portion of the FE architecture of FIGS. 4 and 8.

FIGS. 9A(1), 9A(2), 9A(3), and 9A(4) show more detailed views of FIG. 9A.

FIG. 9B shows a portion of the FE architecture of FIGS. 4, 8 and 9A.

FIGS. 9B(1), 9B(2), 9B(3), and 9B(4) show more detailed views of FIG. 9B.

FIG. 10 shows that in some embodiments, the FE architecture of FIG. 5 can include a splitter configured to split the common Tx RF signal into two signals provided to two separate modules.

FIG. 11 shows that in some embodiments, the FE architecture of FIG. 5 can include a phase-shifting circuit implemented for one of two signals provided to two separate modules.

FIG. 12 shows that in some embodiments, the FE architecture of FIG. 5 can include a phase-shifting circuit implemented for each of two signals provided to two separate modules.

FIG. 13 shows that in some embodiments, the FE architecture of FIG. 3 can be configured such that at least one of the modules includes a DL-only functionality.

FIG. 14 shows an example of a low-noise amplifier (LNA) configuration that can be implemented for the DL-only functionality of FIG. 13.

FIG. 15 shows that in some embodiments, the LNA configuration of FIG. 14 can include a by-pass functionality.

FIG. 16 shows that in some embodiments, some or all of duplexing functionalities of the FE architecture of FIG. 3 can be provided by duplexers.

FIG. 17 shows that in some embodiments, some or all of duplexing functionalities of the FE architecture of FIG. 3 can be provided by separate filters that are switch-combined.

FIG. 18 shows an example where the duplexing configuration of FIG. 17 can be combined with a DL-only functionality similar to the example of FIG. 15.

FIG. 19 shows that in some embodiments, an FE architecture having one or more features as described herein can be implemented in a single packaged module.

FIG. 20 shows that in some embodiments, an FE architecture having one or more features as described herein can be implemented in a plurality of packaged modules.

FIG. 21 shows an example of a wireless device having an FE architecture having one or more features as described herein.

### DETAILED DESCRIPTION OF SOME EMBODIMENTS

The headings provided herein, if any, are for convenience only and do not necessarily affect the scope or meaning of the claimed invention.

Modern 3G and 4G radio architectures for handset (sometimes referred to as user equipment, or UE) can be configured to enable features of receiver (Rx) diversity and downlink-multiple-input-and-multiple-output (DL-MIMO) through the use of an additional antenna (e.g., Rx diversity antenna) with low correlation coefficient to a corresponding primary antenna. Such an architecture can also be configured to enable Rx filtering and radio-frequency (RF) signal conditioning to be received simultaneous with active primary Rx paths. The Rx signal can be an identical copy of the primary Rx signal, in which case the processing gain of the additional power collected by the diversity antenna can be utilized to provide an Rx diversity advantage.

The foregoing architecture can also be configured to enable an operating mode where the second Rx signal received is a different data-stream from the first Rx signal. Such a configuration can facilitate a higher data rate in signal-to-noise (SNR) environments that allow the simultaneous reception of, for example, additional bits in parallel in a DL-MIMO mode of operation.

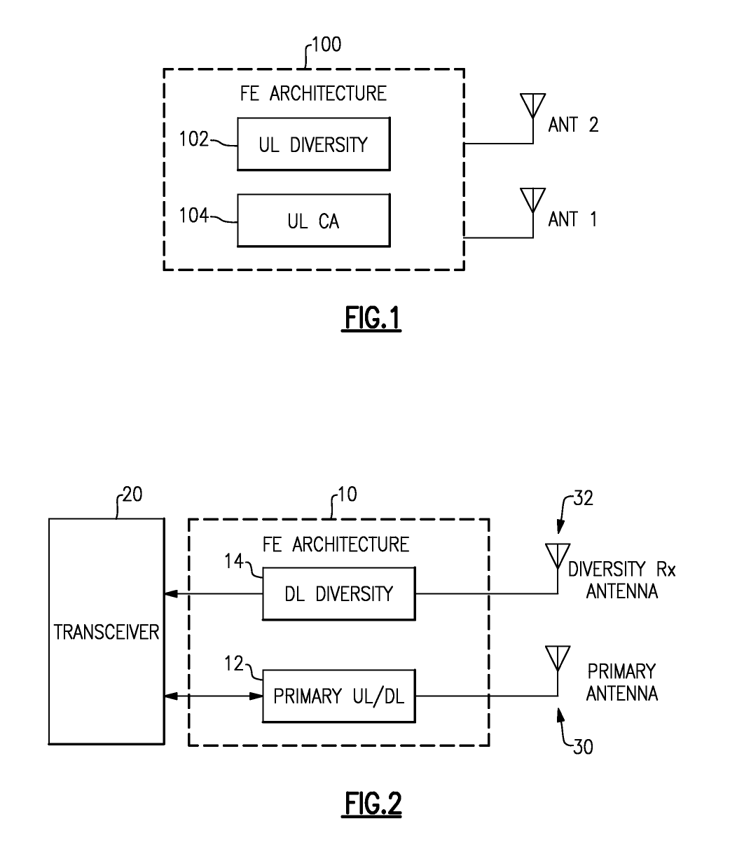

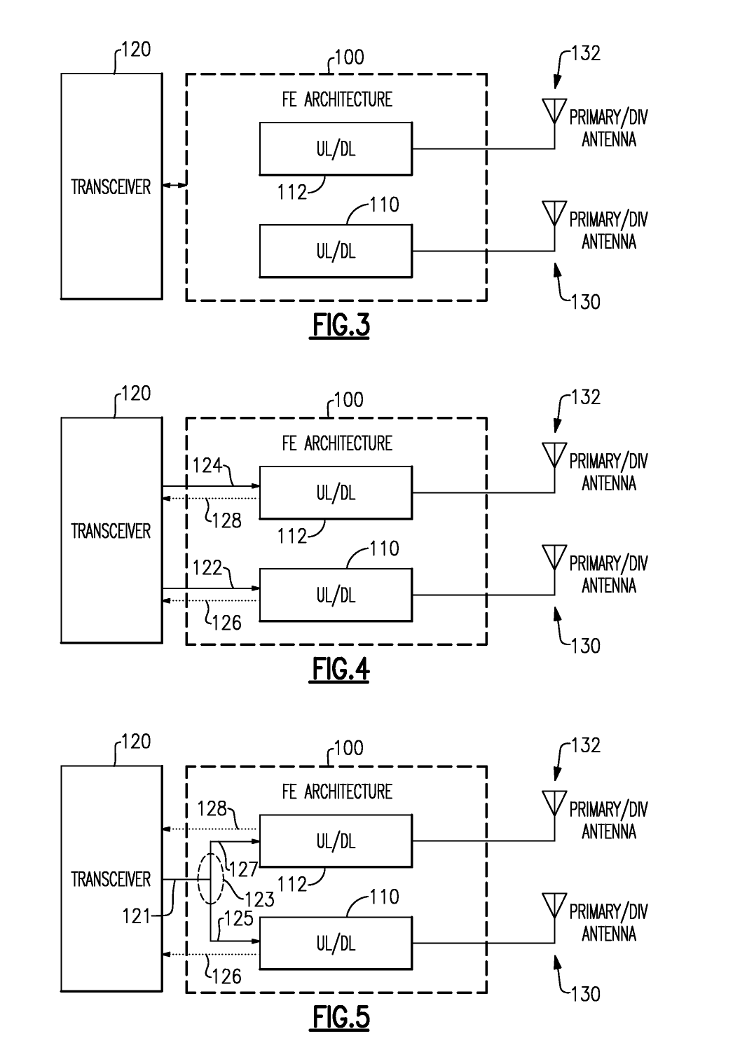

Disclosed are examples related to wireless architectures that include an uplink (UL) diversity capability. In some embodiments, and as described herein, such a wireless architecture can be implemented in a front-end (FE) of a wireless device. FIG. 1 depicts an FE architecture 100 that includes a UL diversity functionality 102. As described herein, such an FE architecture can also include a UL carrier aggregation functionality 104.

FIG. 1 further shows that the FE architecture 100 having one or more features as described herein can be configured to operate with a first antenna (ANT 1) and/or a second antenna (ANT 2). Although various examples are described in the context of two antennas, it will be understood that one or more features of the present disclosure can also be implemented utilizing different numbers (e.g. more than two) of antennas.

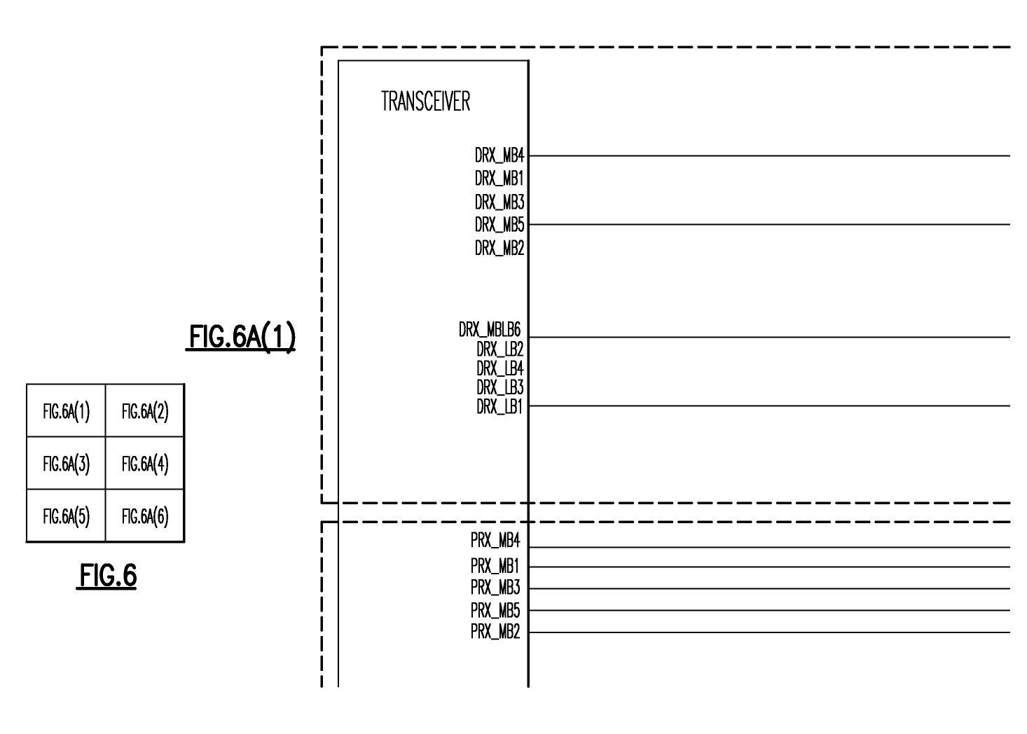

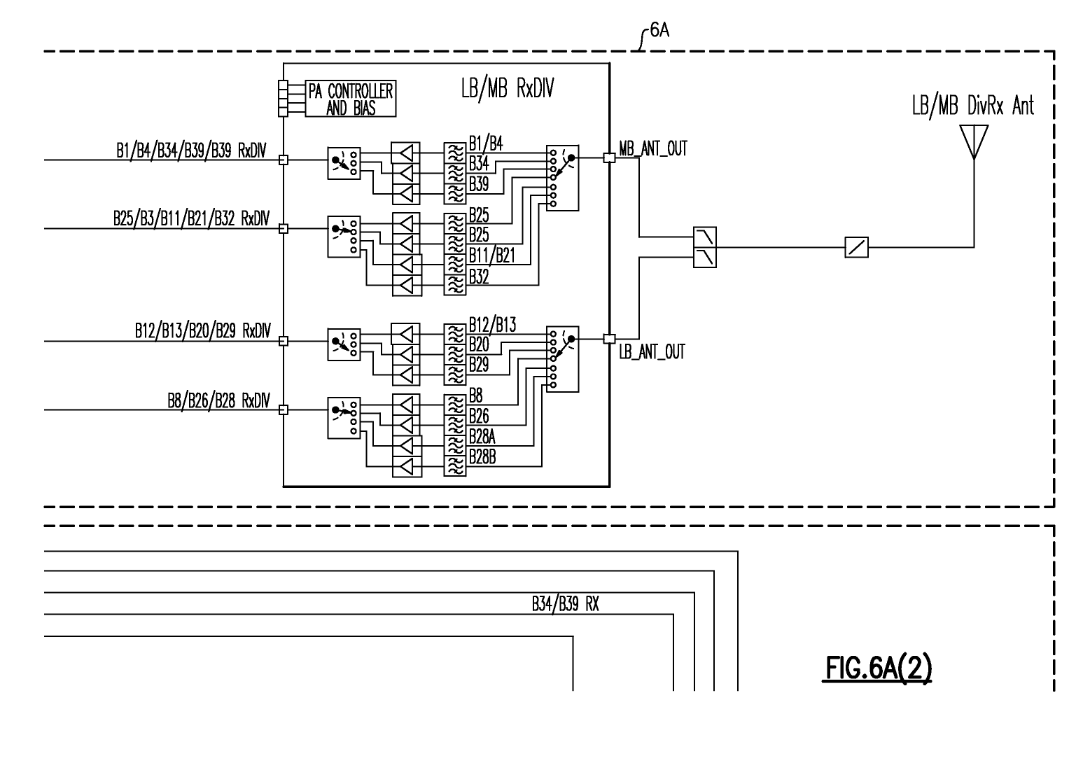

FIG. 2 depicts an example of a conventional FE architecture 10 in which a primary UL/DL functionality 12 can be implemented with use of a primary antenna 30, and a DL diversity functionality 14 can be implemented with use of a diversity Rx antenna 32. The FE architecture 10 can be in communication with a transceiver 20, and such a transceiver can be configured to generate Tx signals and process Rx signals associated with the primary UL/DL component 12, as well as process Rx signals associated with the DL diversity component 14.

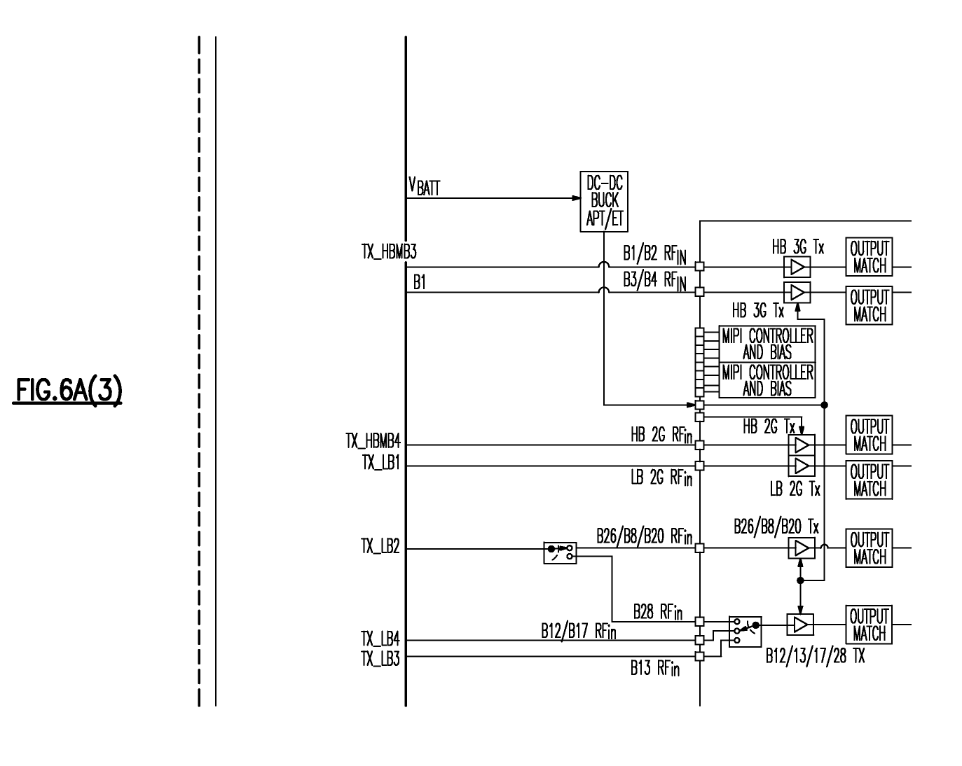

FIG. 3 depicts an FE architecture 100 that includes a UL diversity functionality. In some embodiments, such a UL diversity functionality can be facilitated by a first module 110 configured for UL/DL operations, and a second module 112 also configured for UL/DL operations. The first module 110 can be in communication with a first antenna 130, and the second module 112 can be in communication with a second antenna 132. The first antenna 130 can be configured to provide primary and/or diversity functionality. Similarly, the second antenna 132 can be configured to provide primary and/or diversity functionality.

In the example of FIG. 3, the first module 110 and the second module 112 can be configured to provide UL/DL functionalities for one or more common frequency bands. Examples of such frequency bands are described herein in greater detail. In some embodiments, the first and second modules 110, 112 can be substantially similar or identical; however, it will be understood that in other embodiments, the first and second modules 110, 112 do not necessarily need to be identical to each other.

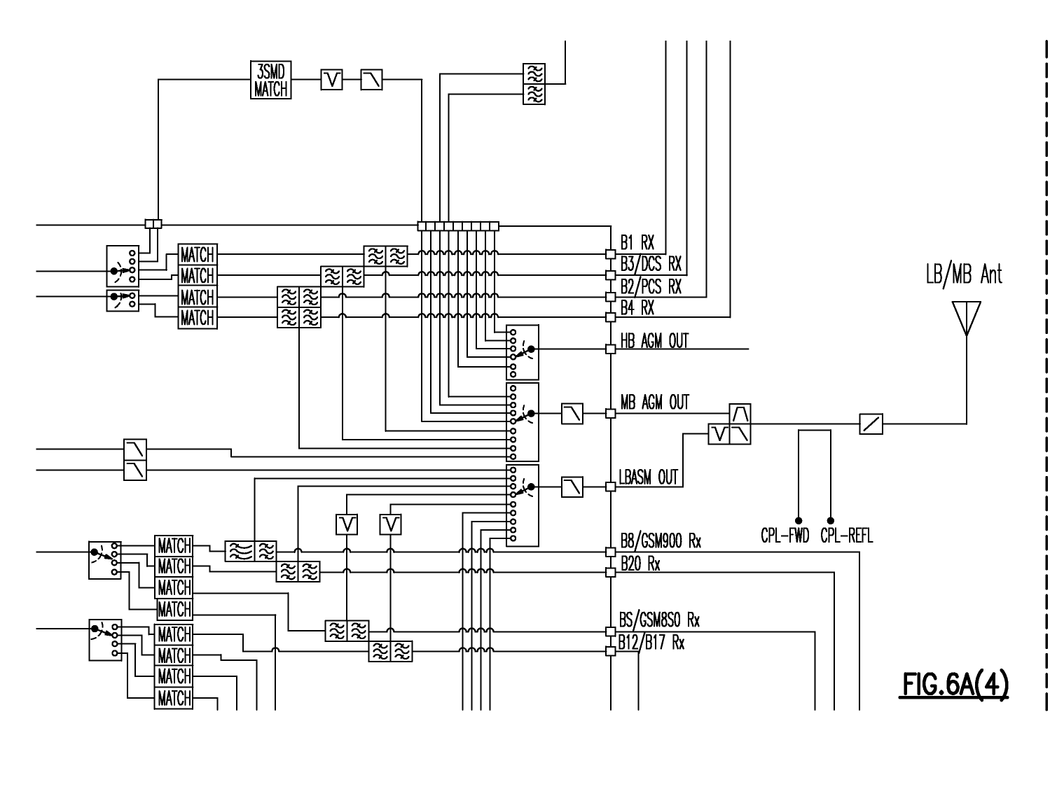

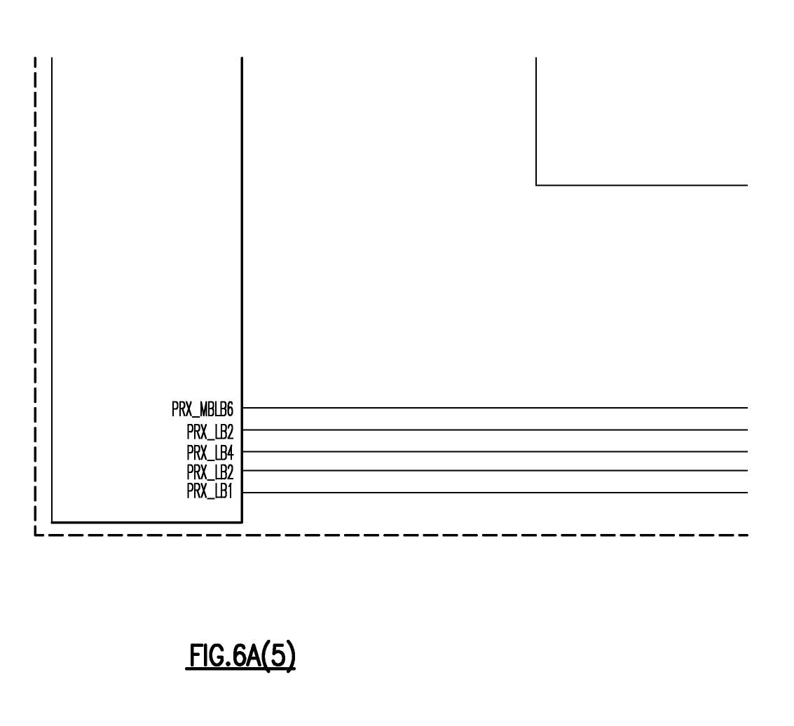

In the example of FIG. 3, the FE architecture 100 is shown to be in communication with a transceiver 120. Such communication between the transceiver 120 and the FE architecture 100 can be configured in different manners. For example, FIG. 4 shows that in some embodiments, each UL/DL module (110 or 112) can have a separate dedicated RF drive path from the transceiver 120 for one or more Tx signals. For the first UL/DL module 110, such a dedicated RF drive path is indicated as arrow 122. For the second UL/DL module 112, such a dedicated RF drive path is indicated as arrow 124.

In the example of FIG. 4, each UL/DL module (110 or 112) can also have a separate dedicated path to the transceiver 120 for one or more Rx signals. For the first UL/DL module 110, such a dedicated Rx path is indicated as arrow 126. For the second UL/DL module 112, such a dedicated Rx path is indicated as arrow 128. It will be understood that other DL configurations can also be implemented for the FE architecture 100.

When configured as shown in the example of FIG. 4, the FE architecture 100 can allow processing of independent RF datastreams through the two UL/DL modules 110, 112 to provide, for example, UL-MIMO functionality. For example, phase and data can be adjusted independently for the RF datastreams, and performance can be optimized for each RF drive path, so as to enable an effective UL-MIMO functionality.

For the purpose of description herein, it will be understood that a MIMO (multiple-input-and-multiple-output) configuration can include a plurality of inputs and/or a plurality of outputs. For example, and as shown in the example of FIG. 4, an FE architecture can include two input signal paths in communication with a transceiver, and two output signal paths in communication with two respective antennas. It will be understood that there can be other numbers of inputs and/or outputs in a MIMO configuration. It will also be understood that the number of inputs may or may not be the same as the number of outputs.

In another example, FIG. 5 shows that in some embodiments, the UL/DL modules (110 and 112) can be coupled to the transceiver 120 through a common Tx signal path 121. Such a common Tx signal path can be split into a Tx signal path for each of the UL/DL modules (110 and 112). For the first UL/DL module 110, such a Tx signal path is indicated as arrow 125. For the second UL/DL module 112, such a Tx signal path is indicated as arrow 127. Splitting of the common signal path 121 into the two example Tx signal paths 125, 127 is depicted as 123. Examples related to such splitting are described herein in greater detail.

In the example of FIG. 5, each UL/DL module (110 or 112) can have a separate dedicated path to the transceiver 120 for one or more Rx signals. For the first UL/DL module 110, such a dedicated Rx path is indicated as arrow 126. For the second UL/DL module 112, such a dedicated Rx path is indicated as arrow 128. It will be understood that other DL configurations can also be implemented for the FE architecture 100.

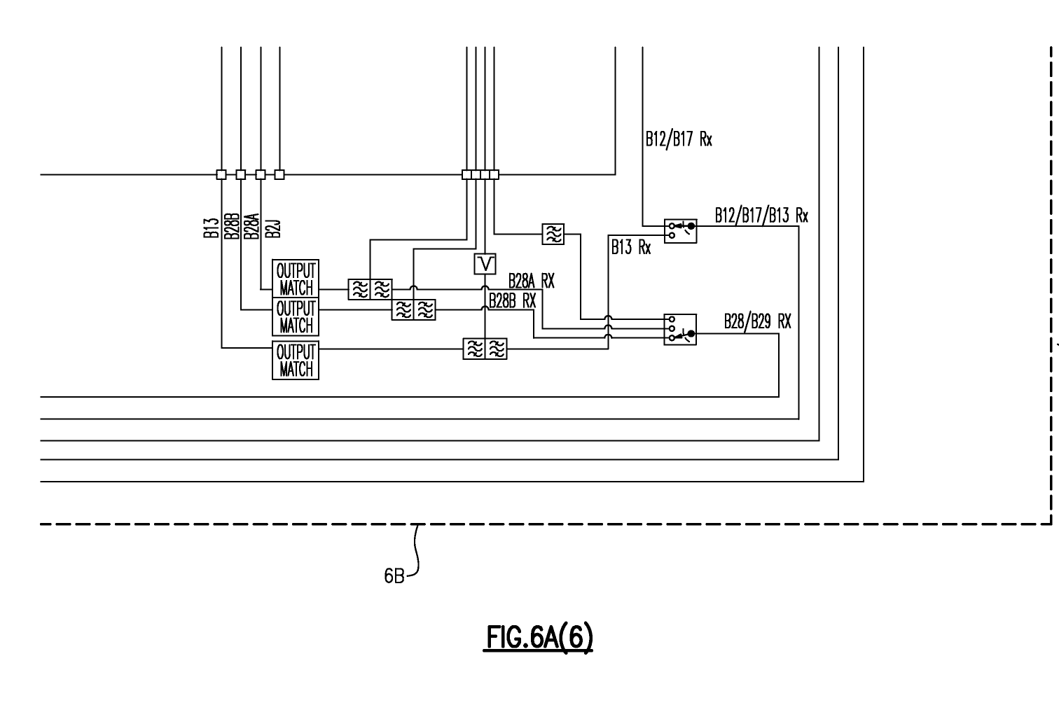

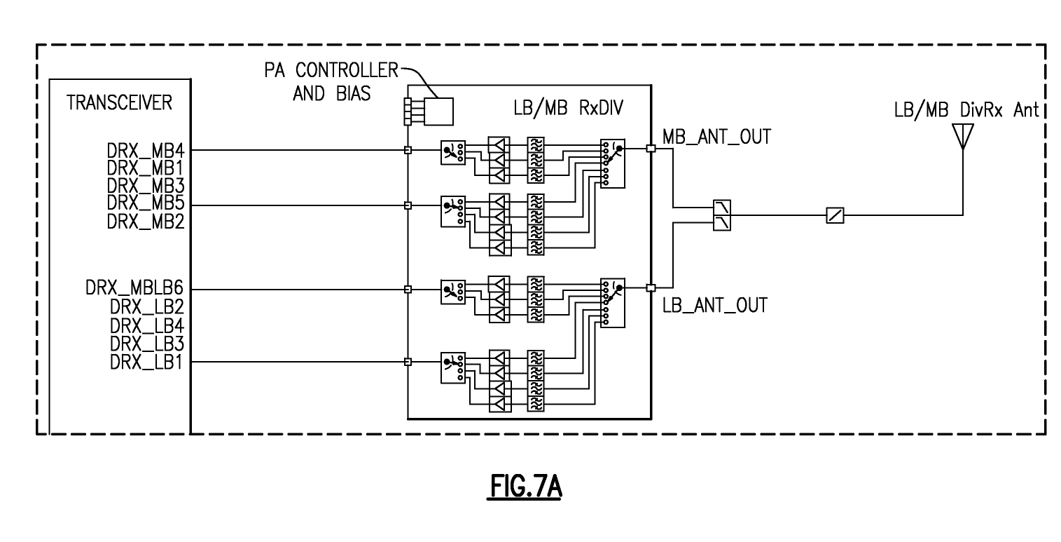

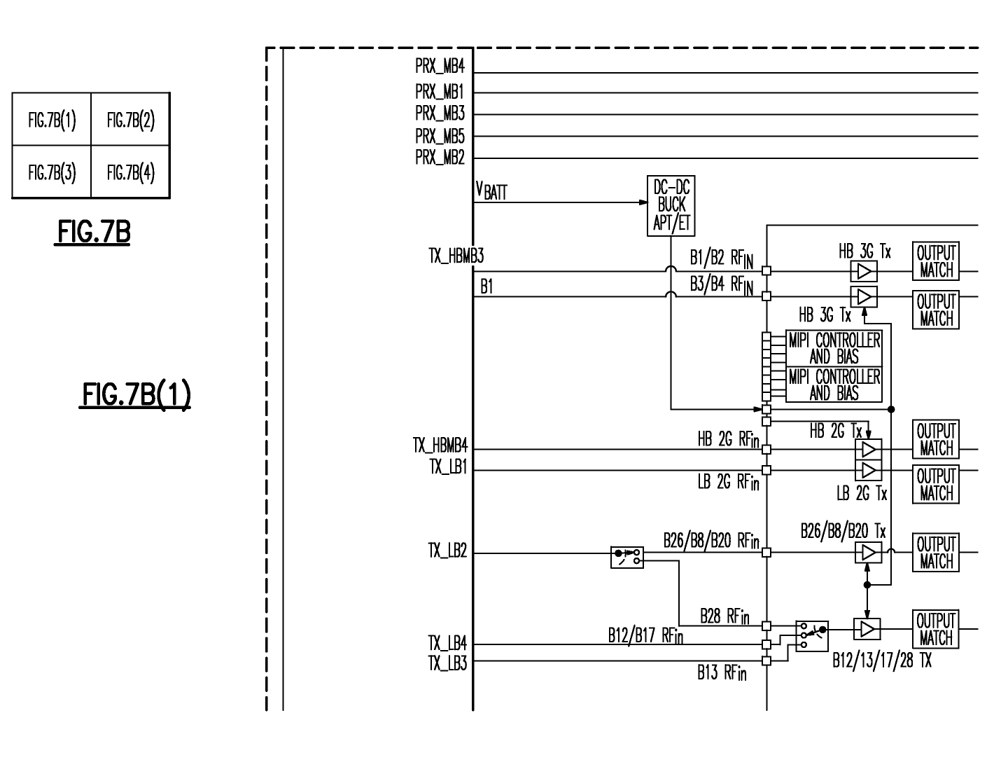

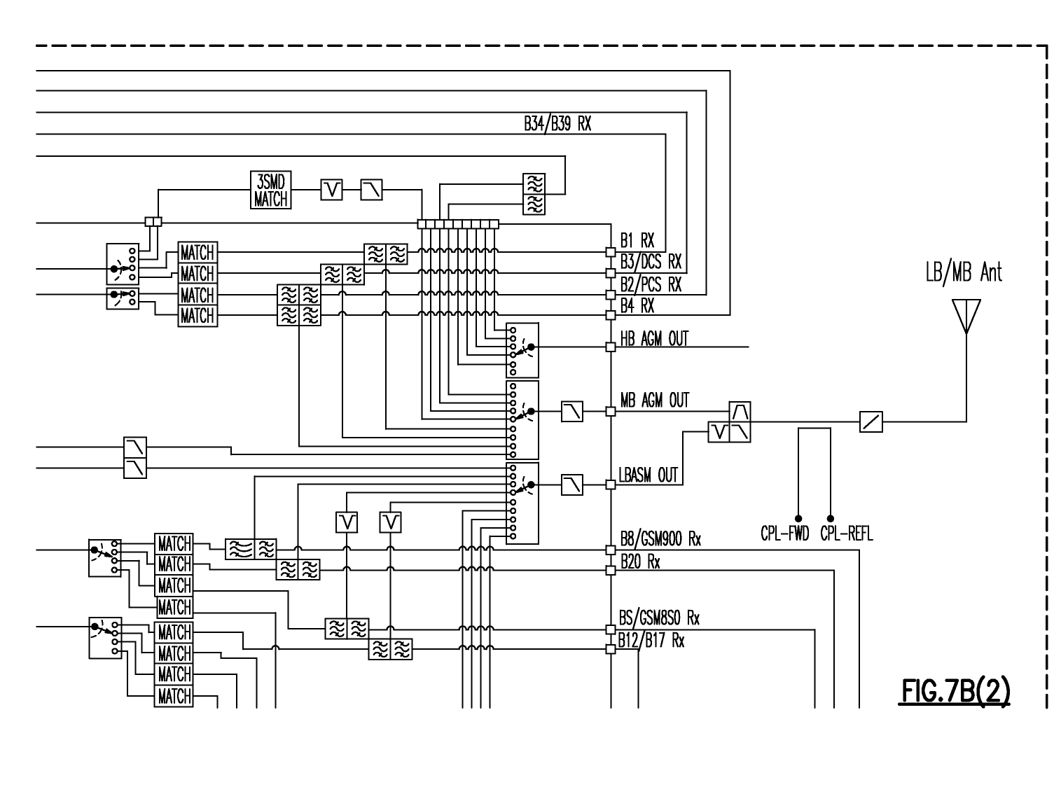

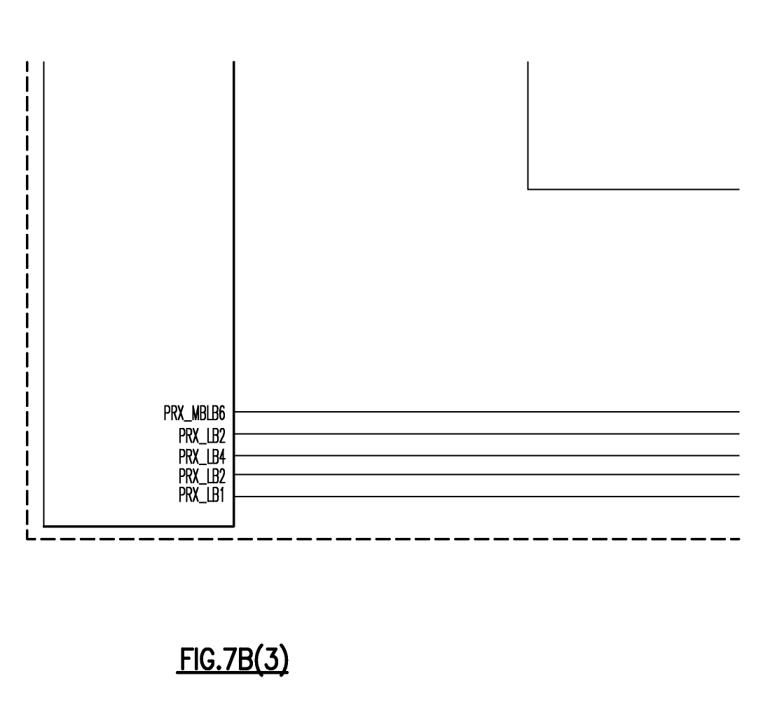

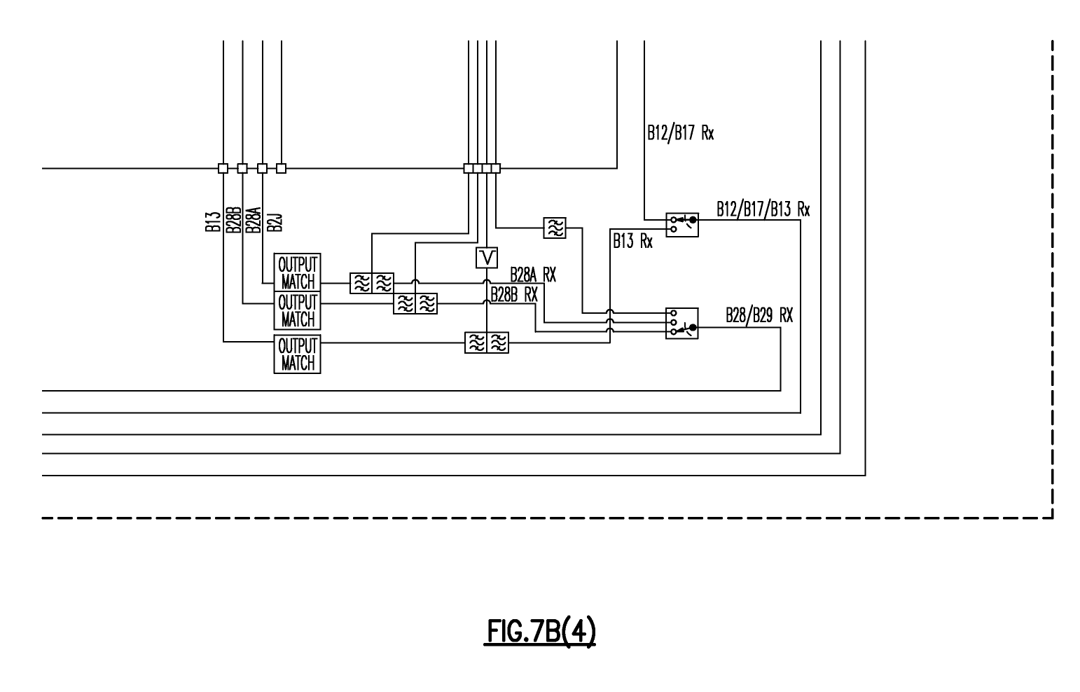

FIGS. 6, 6A(1)-6A(6), 7A, 7B and 7B(1)-7B(4) show a more specific example of the FE architecture 10 of FIG. 2. More particularly, FIG. 6 is representative of the overall FE architecture 10, with FIGS. 6A(1)-6A(6) showing various portions as indicated in FIG. 6. FIG. 7A shows the Rx portion of the FE architecture 10, and FIG. 7B is representative of the Tx portion of the FE architecture 10. FIGS. 7B(1)-7B(4) show various portions of FIG. 7B as indicated.

In the example of FIGS. 6, 6A(1)-6A(6), 7A, 7B and 7B(1)-7B(4), the Tx portion can be an implementation of a module having the primary UL/DL functionality 12 as described in reference to FIG. 2. Such a module can be configured to provide multi-band duplexing functionality for a number of cellular bands in low-band (LB) and mid-band (MB). For example, Tx signals in LB, such as B26/B8/B20, B28, B12/B17 and B13 are shown to be amplified by their respective power amplifiers (PAs), and routed to respective duplexers and/or filters through switches and matching networks. Such amplified and filtered Tx signals are shown to be routed to a primary antenna (e.g., 30 in FIG. 2) through an antenna switch. In the example shown, a 2G Tx signal in LB can also be amplified, filtered, and routed to the primary antenna.

Referring to the Tx portion of the primary UL/DL module (12 in FIG. 2), Tx signals in MB, such as B1/B2 and B3/B4 are shown to be amplified by their respective power amplifiers (PAs), and routed to respective duplexers and/or filters through switches and matching networks. Such amplified and filtered Tx signals are shown to be routed to the primary antenna through an antenna switch. In the example shown, a 2G Tx signal in its high-band (HB) can also be amplified, filtered, and routed to the primary antenna.

In the example of FIGS. 6, 6A(1)-6A(6), 7A, 7B and 7B(1)-7B(4), the Rx portion can be an implementation of a module having the DL diversity functionality 14 as described in reference to FIG. 2. Such a module can be configured to provide Rx diversity functionality for a number of cellular bands in low-band (LB) and mid-band (MB). For example, Rx signals in LB, such as B12/B13, B20, B29, B8, B26, B28A and B28B are shown to be received through a diversity Rx antenna (e.g., 32 in FIG. 2) and routed to their respective filters and low-noise amplifiers (LNAs) through one or more antenna switches. In another example, Rx signals in MB, such as B1/B4, B34, B39, B25, B3, B11/21 and B32 are shown to be received through the diversity Rx antenna and routed to their respective filters and LNAs through one or more antenna switches.

Configured in the foregoing manner, the FE architecture 10 of FIGS. 2, 6, 6A(1)-6A(6), 7A, 7B and 7B(1)-7B(4) can provide Rx diversity for a number of cellular bands, including some or all of B26, B8, B20, B28, B12 and B13 for LB Rx bands, and B1, B2, B3 and B4 for MB Rx bands. However, it is noted that in the FE architecture 10, Tx diversity functionality is generally not possible.

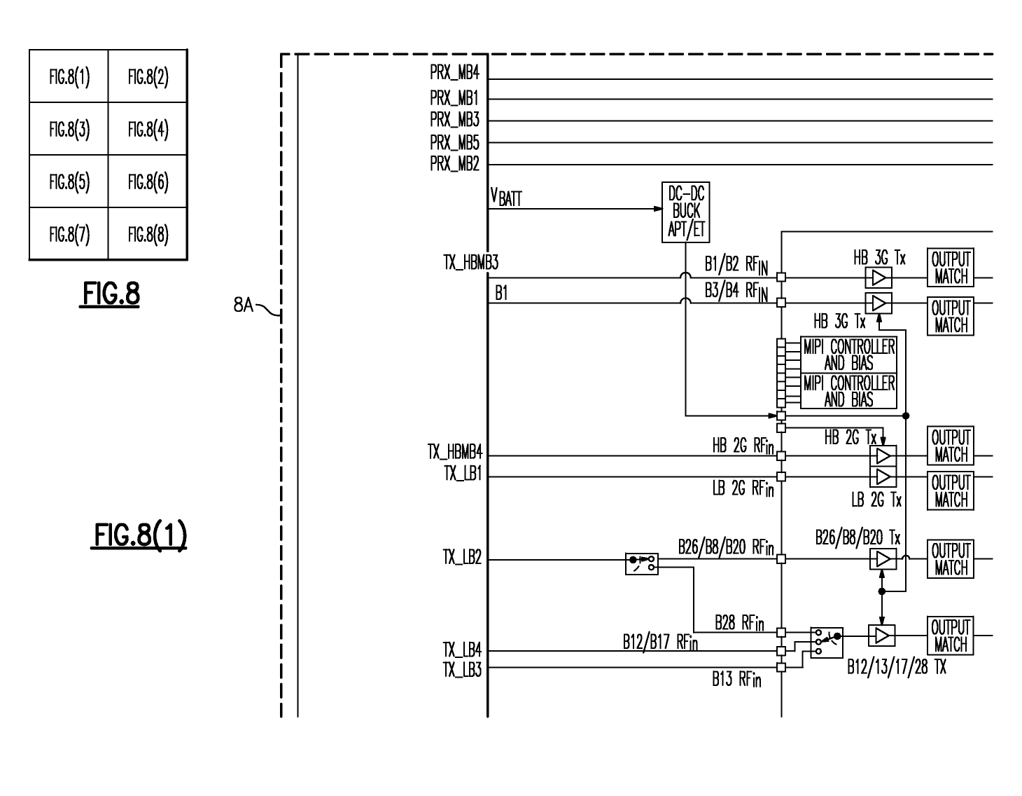

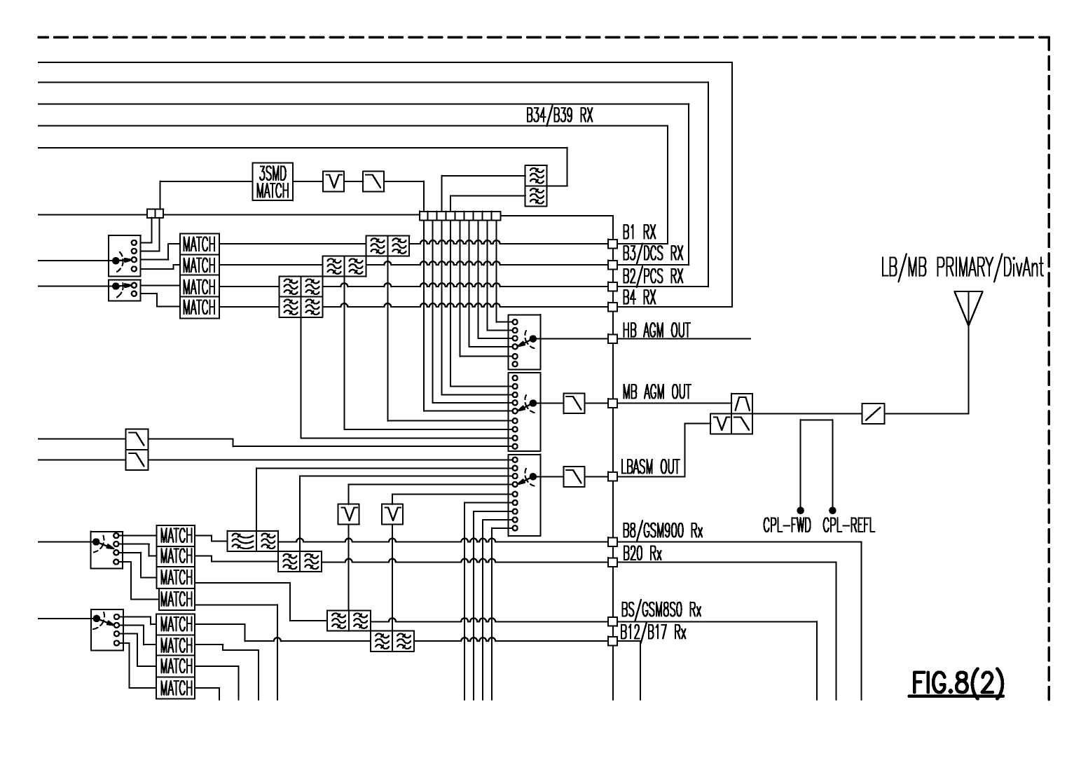

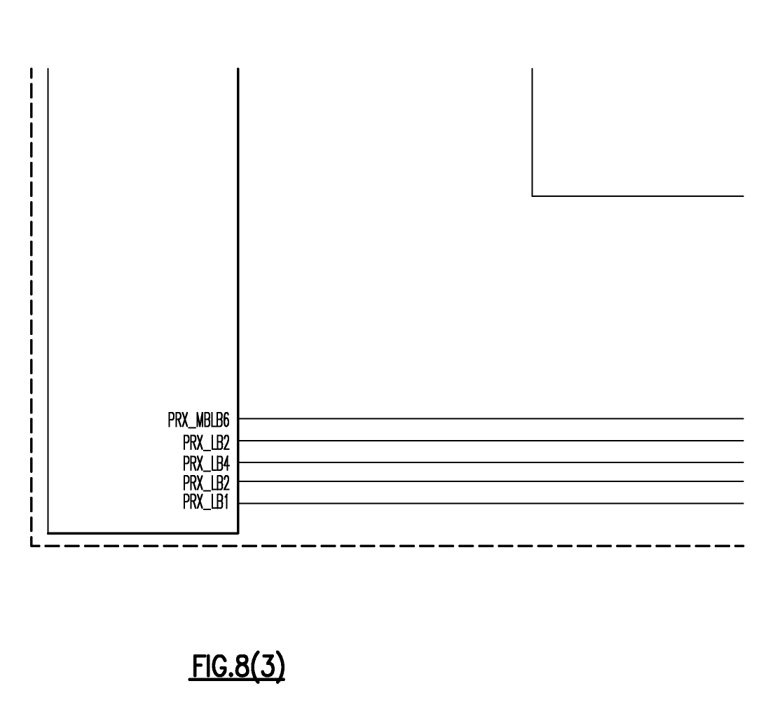

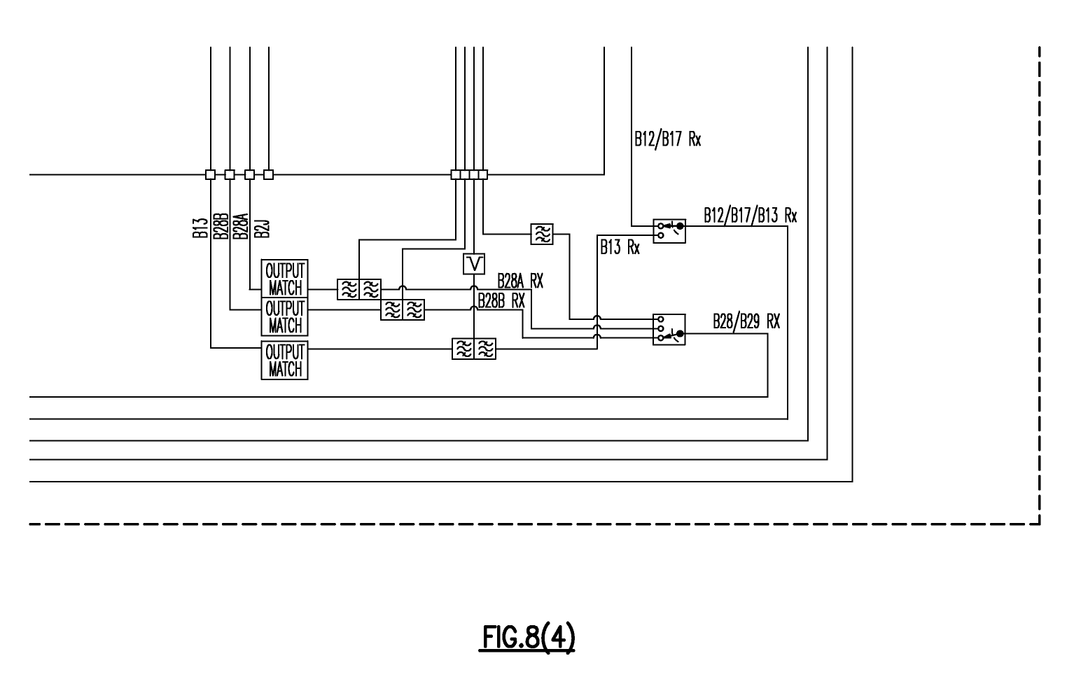

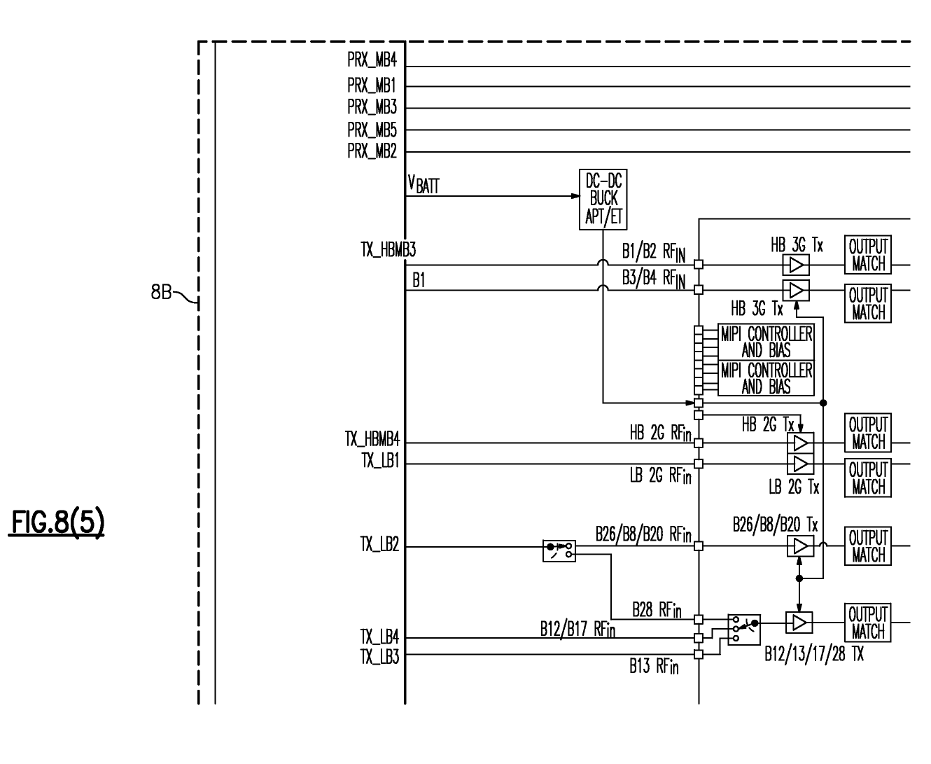

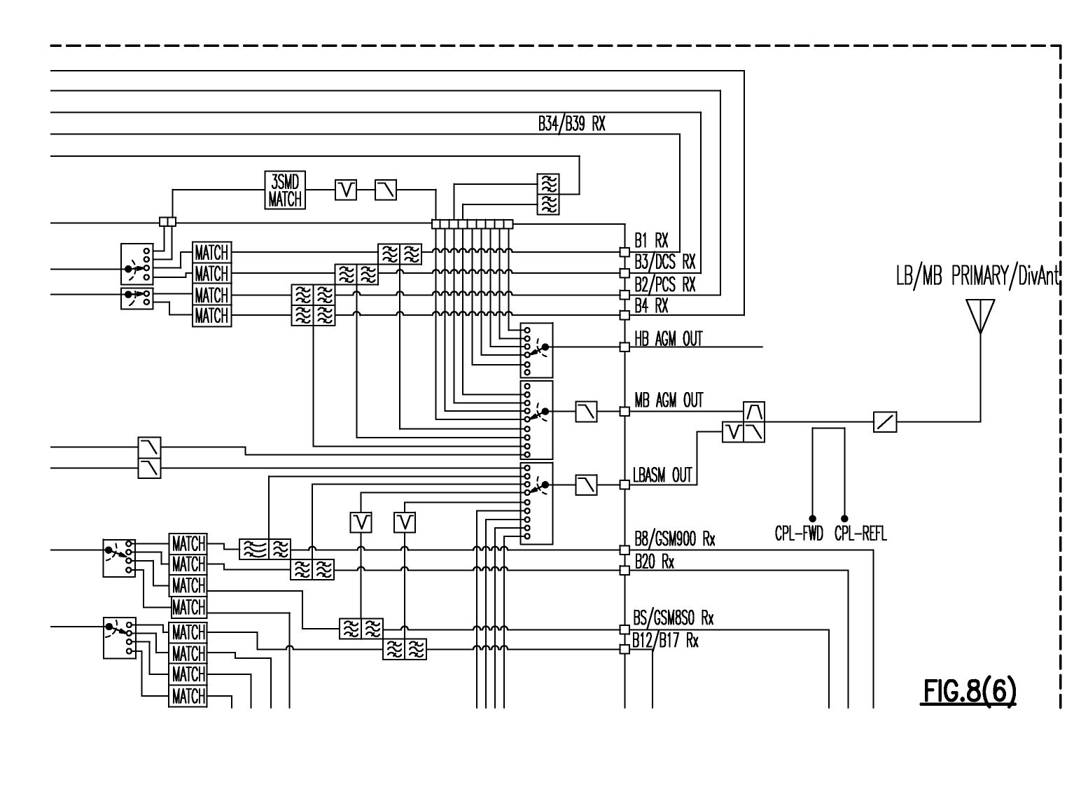

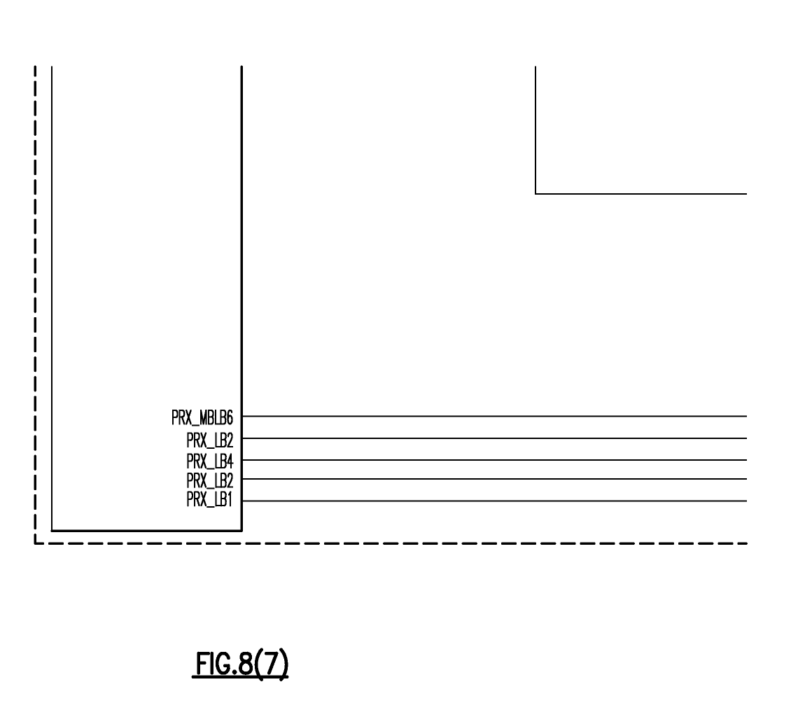

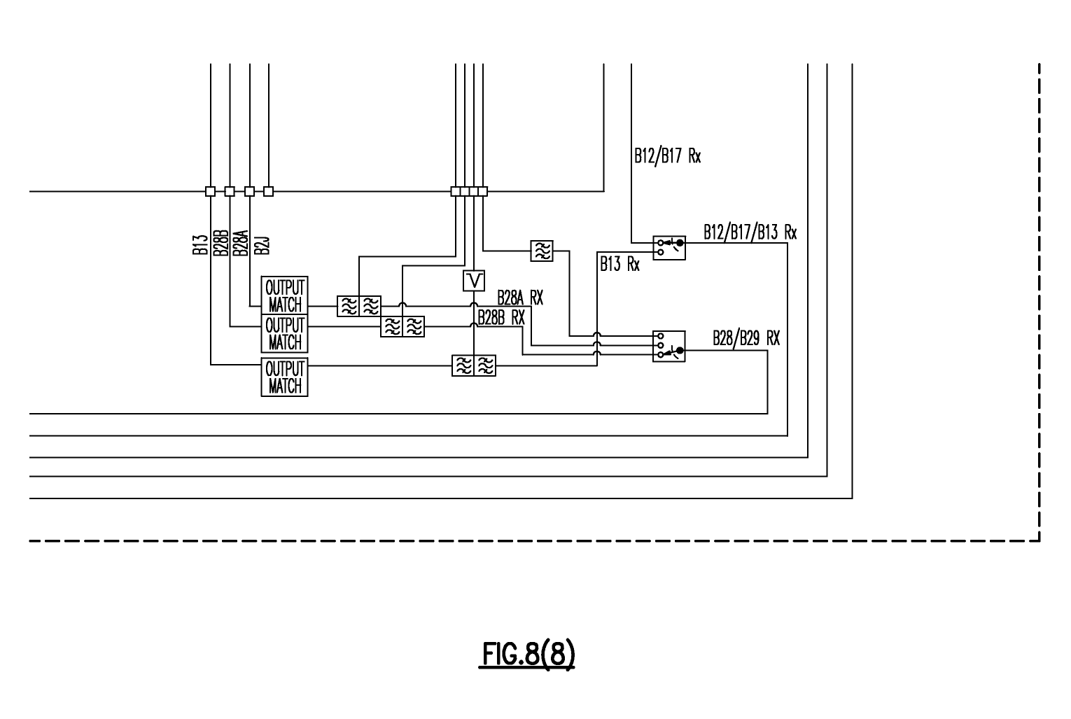

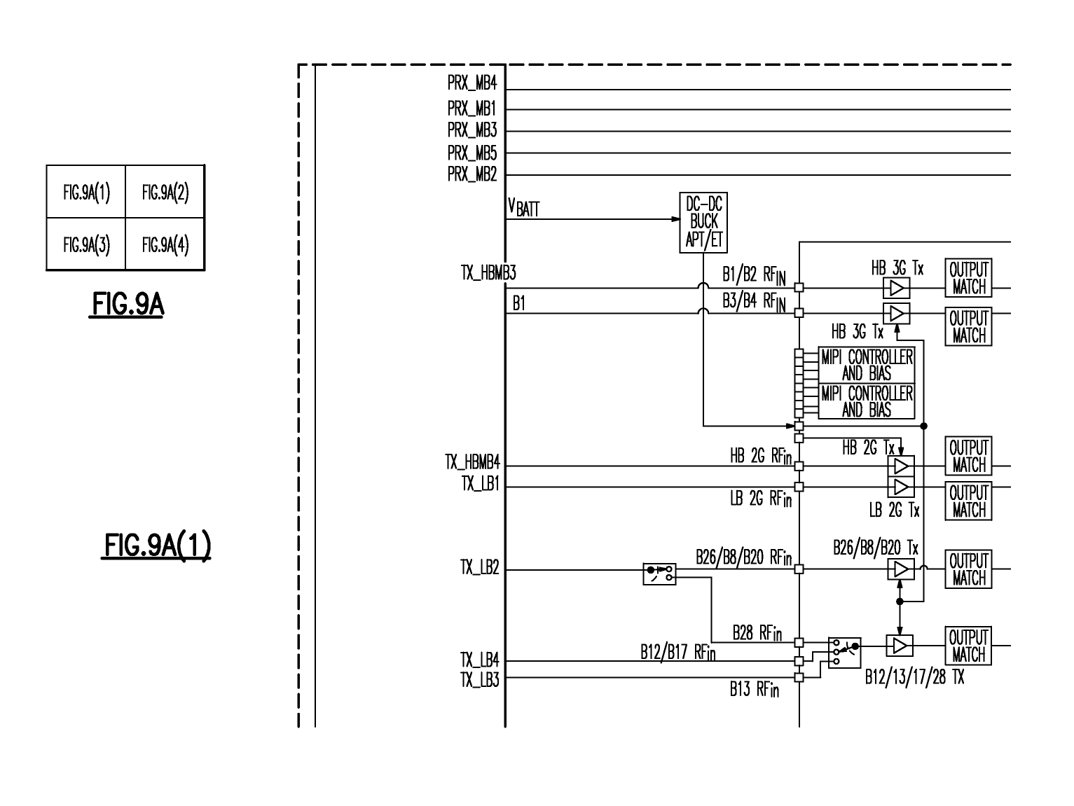

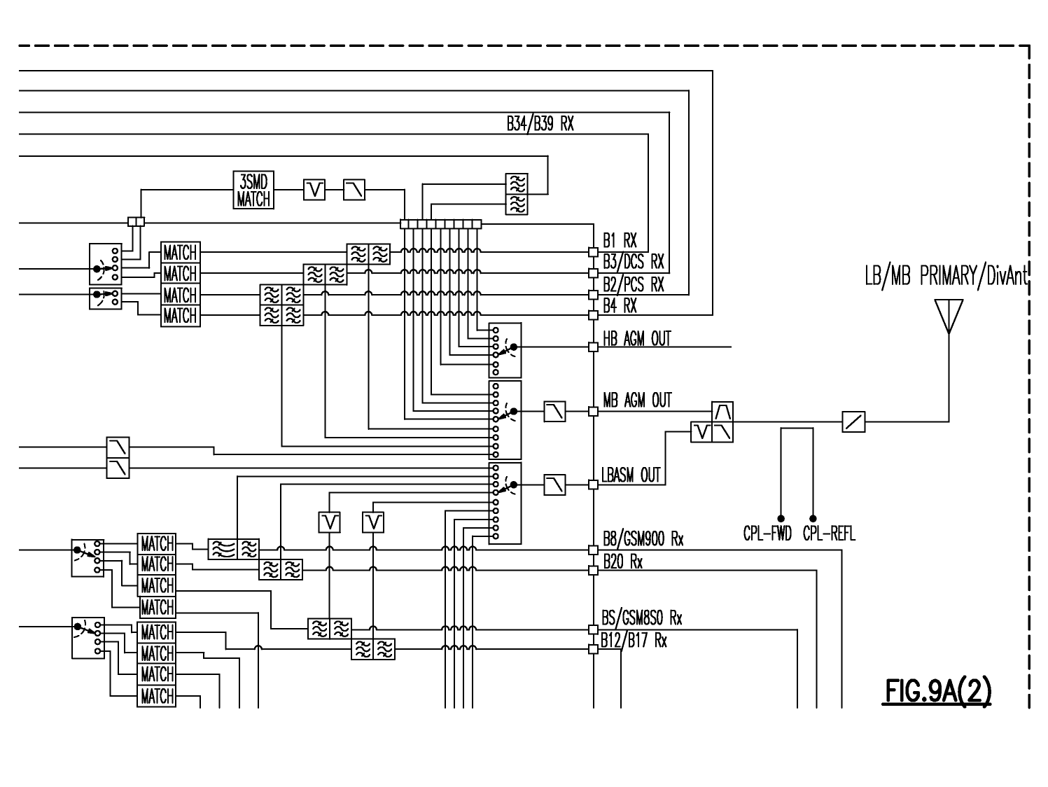

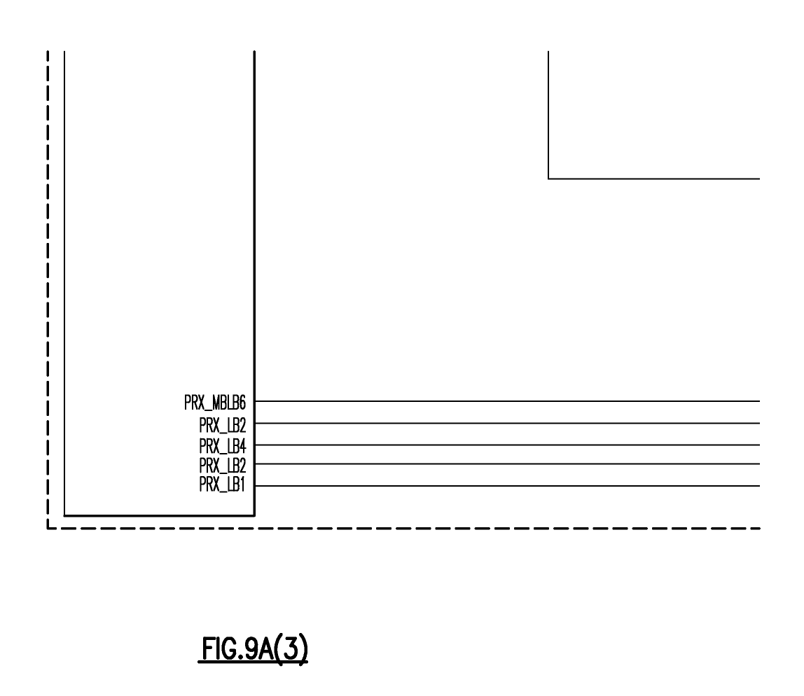

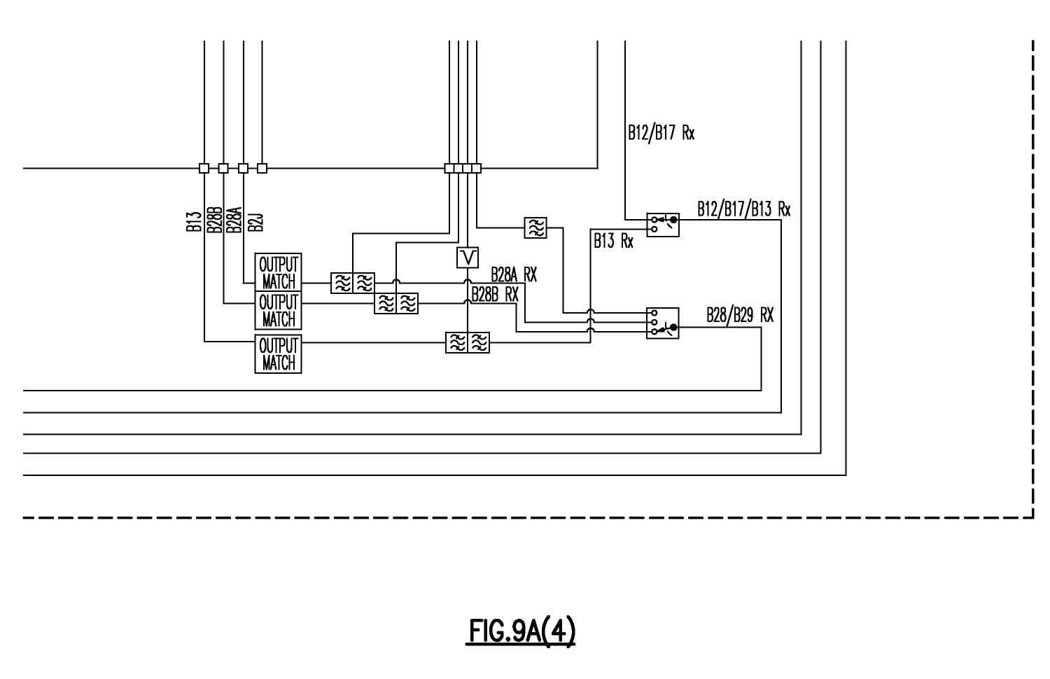

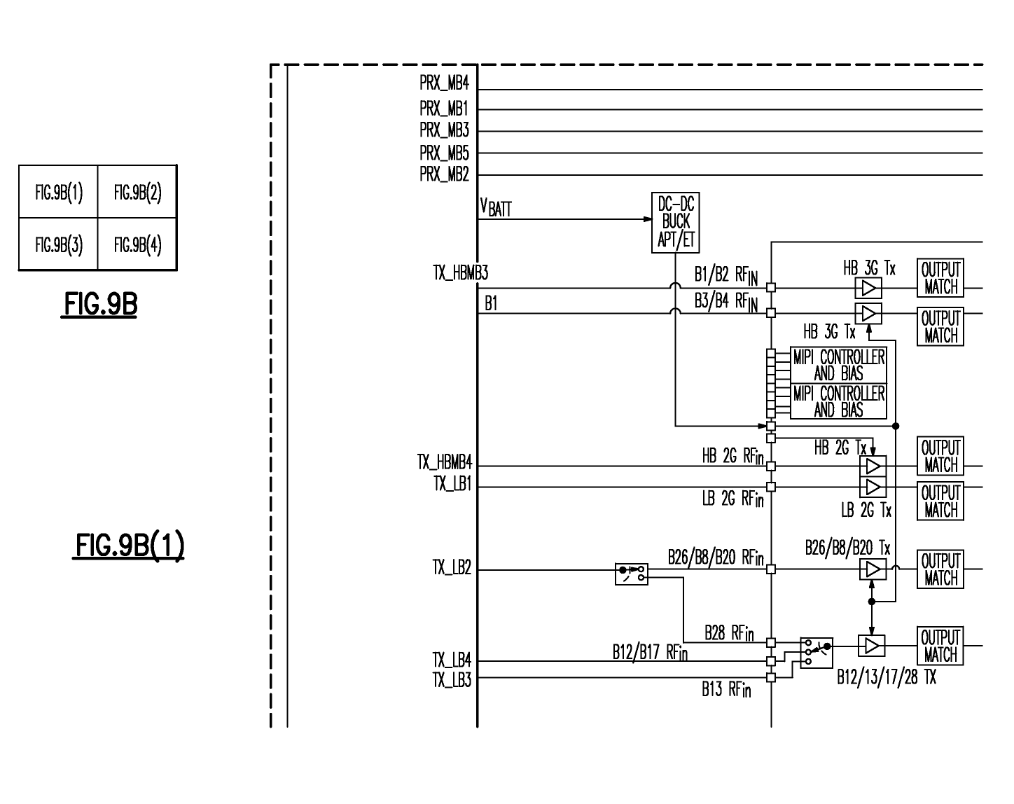

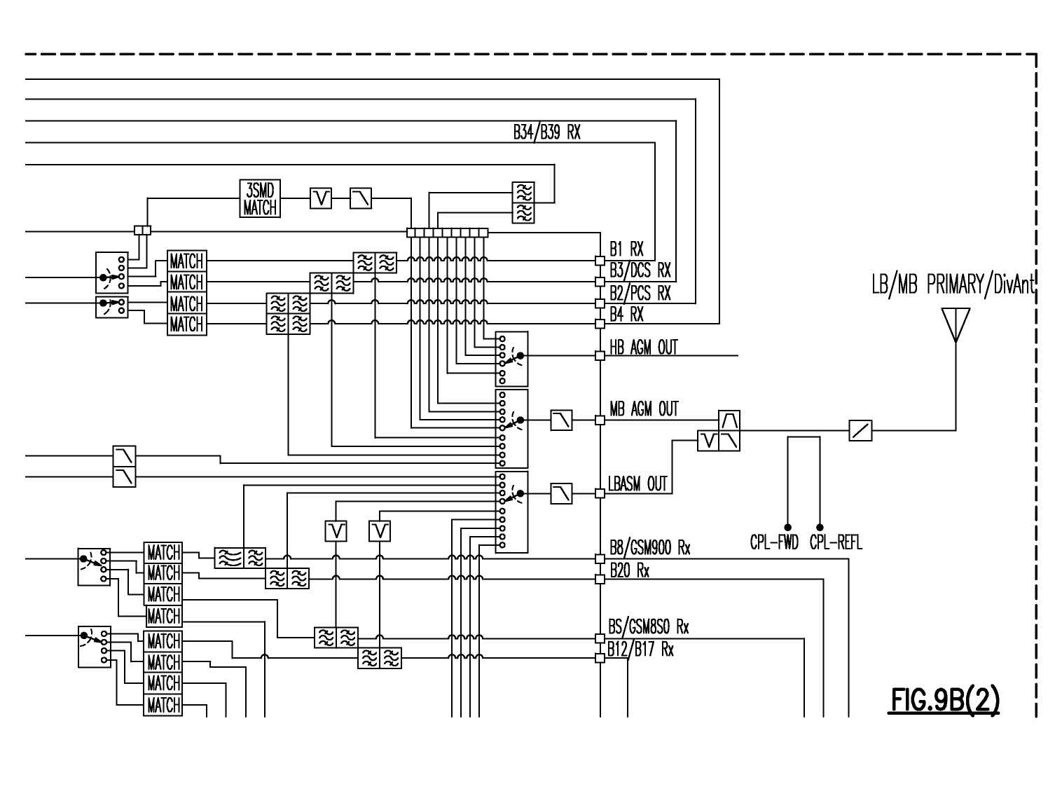

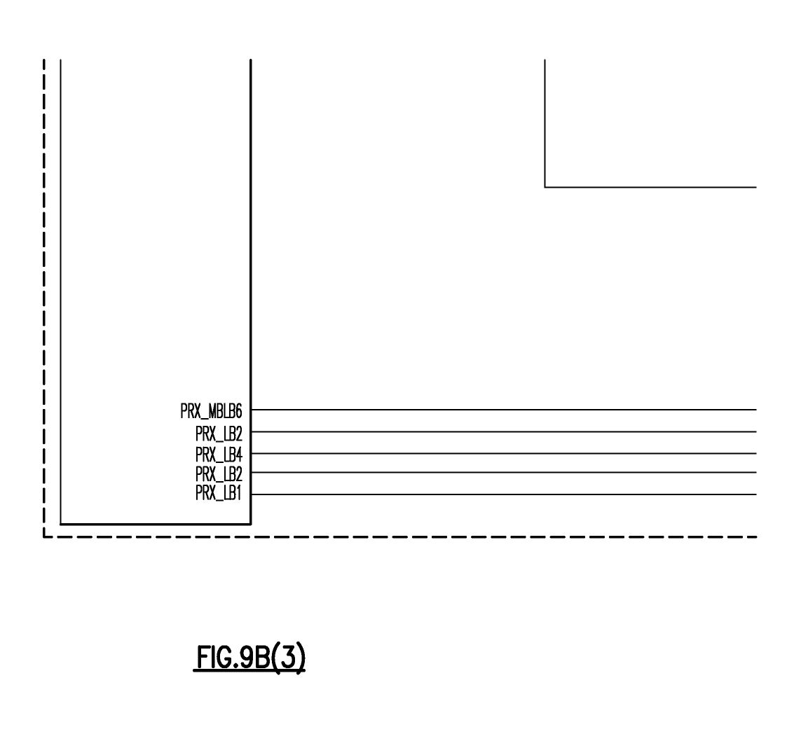

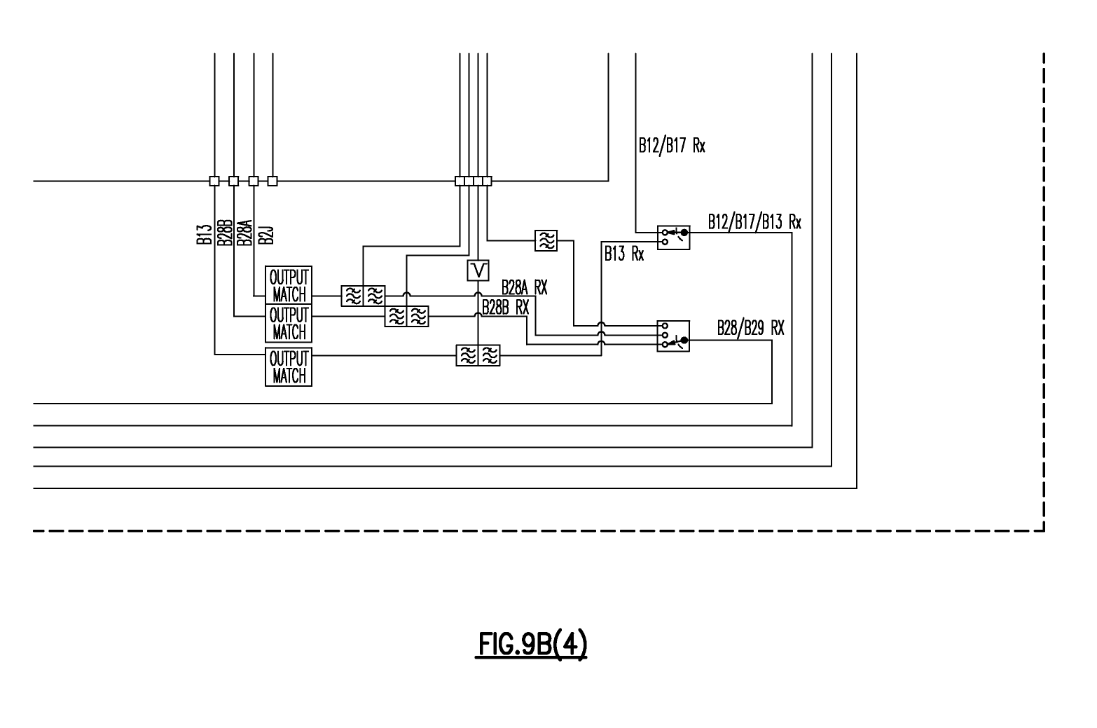

FIGS. 8, 8(1)-8(8), 9A, 9A(1)-9A(4), 9B and 9B(1)-9B(4) show a more specific example of the FE architecture 100 of FIGS. 3 and 4. More particularly, FIG. 8 is representative of the overall FE architecture 100, with FIGS. 8(1)-8(8) showing various portions as indicated in FIG. 8. FIG. 9A is representative of one Tx/Rx portion of the FE architecture 100, and FIG. 9B is representative of another Tx/Rx portion of the FE architecture 100. FIGS. 9A(1)-9A(4) show various portions of FIG. 9A as indicated, and FIGS. 9B(1)-9B(4) show various portions of FIG. 9B as indicated.

In the example of FIGS. 8, 8(1)-8(8), 9A, 9A(1)-9A(4), 9B and 9B(1)-9B(4), the first of the two Tx/Rx portions of the FE architecture 100 can be implemented as a first UL/DL module (e.g., 110 in FIG. 4), and the second of the two Tx/Rx portions of the FE architecture 100 can be implemented as a second UL/DL module (e.g., 112 in FIG. 4). In some embodiments, the first UL/DL module in the example of FIGS. 8, 8(1)-8(8), 9A, 9A(1)-9A(4), 9B and 9B(1)-9B(4) can be similar or substantially the same as the primary UL/DL module of FIGS. 6, 6A(1)-6A(6), 7A, 7B and 7B(1)-7B(4). Accordingly, various examples of cellular bands that can be supported by the first UL/DL module (110) for Tx and Rx operations can be similar to the examples described in reference to FIGS. 6, 6A(1)-6A(6), 7A, 7B and 7B(1)-7B(4).

In some embodiments, the second UL/DL module (112) in the example of FIGS. 8, 8(1)-8(8), 9A, 9A(1)-9A(4), 9B and 9B(1)-9B(4) can be similar or substantially the same as the first UL/DL module (110) in the same FE architecture 100. Accordingly, various examples of cellular bands that can be supported by the second UL/DL module (112) for Tx and Rx operations can be similar to the examples described in reference to FIGS. 6, 6A(1)-6A(6), 7A, 7B and 7B(1)-7B(4).

It will be understood that the either or both of the UL/DL modules of FIGS. 8, 8(1)-8(8), 9A, 9A(1)-9A(4), 9B and 9B(1)-9B(4) may or may not be the same as the primary UL/DL module of FIGS. 6, 6A(1)-6A(6), 7A, 7B and 76(1)-7B(4). It will also be understood that the first and second UL/DL modules of the FE architecture 100 of FIGS. 8, 8(1)-8(8), 9A, 9A(1)-9A(4), 9B and 9B(1)-9B(4) may or may not be the same. In embodiments where such first and second UL/DL modules of the FE architectures are substantially the same, inputs and/or outputs to such UL/DL modules may or may not be configured the same.

In the example of FIGS. 8, 8(1)-8(8), 9A, 9A(1)-9A(4), 9B and 9B(1)-9B(4), each of the two UL/DL modules is shown to be in communication with the transceiver. Accordingly, the FE architecture 100 of FIGS. 8, 8(1)-8(8), 9A, 9A(1)-9A(4), 9B and 9B(1)-9B(4) can support or be capable of supporting UL-MIMO functionality, similar to the example of FIG. 4.

As described in reference to FIG. 5, an FE architecture having UL diversity does not necessarily need to have UL-MIMO functionality. As also described in reference to FIG. 5, such an FE architecture can be configured to process a common Tx signal from a transceiver through implementation of, for example, a signal splitting configuration (123 in FIG. 5).

FIG. 10 shows an example of the signal splitting configuration 123 of FIG. 5. In the example of FIG. 10, a splitter circuit 129 can be configured to provide such signal splitting functionality. Such a splitter circuit can be configured to receive a common Tx signal from the transceiver through a common path 121, and split the common Tx signal into first and second signal paths 125, 127. The first signal path 125 can provide the first split Tx signal to the first UL/DL module (110 in FIG. 5), and the second signal path 127 can provide the second split Tx signal to the second UL/DL module (112 in FIG. 5).

In some embodiments, the splitter circuit 129 can be implemented in a number of ways. For example, resistive splitting, Wilkinson splitting, etc. can be utilized. It will be understood that other implementations of the splitter circuit 129 can also be utilized.

In some embodiments, an FE architecture such as the example of FIG. 5 can include one or more phase shifters for the split Tx signals. For example, FIG. 11 shows that in some embodiments, one of the two split Tx signal paths can include a phase shifting circuit. In the example of FIG. 11, the split Tx signal path 125 is shown to include a phase shifting circuit 140. Similarly, the split Tx signal path 127 can include a phase shifting circuit instead of the split Tx signal path 125.

FIG. 12 shows that in some embodiments, each of the two split Tx signal paths 125, 127 can include a phase shifting circuit. In the example of FIG. 12, a first phase shifting circuit 140 is shown to be implemented along the first Tx signal path 125, and a second phase shifting circuit 142 is shown to be implemented along the second Tx signal path 127.

In some embodiments, the foregoing phase shifting examples can be configured to be fixed, adjustable (e.g., analog-adjusted), or any combination thereof. Such phase shifting functionality can be selected to provide, for example, optimal adjustment of the multipath and transmission characteristics. In some embodiments, the foregoing examples of phase shifting circuits can be implemented within the splitter circuit 129, along one or more of the Tx signal paths following the splitter circuit, or any combination thereof.

It is noted that in some wireless applications, a radio's improvement in uplink (Tx) performance can be achieved at least partially through uplink Tx diversity as described herein. Also, UL-MIMO functionality can be enabled by an FE architecture having one or more features as described herein. Such advantageous features can allow more effective communication of either or both of the same and unique Tx datastreams with an eNodeB. It is further noted that the foregoing UL Tx diversity and/or UL-MIMO features are generally not possible with conventional front-end architecture such as the examples of FIGS. 2, 6, 6A(1)-6A(6), 7A, 7B and 7B(1)-7B(4).

In some embodiments, replacement of a diversity receive module with a second Tx/Rx capable front-end module can allow a previously limited diversity-only antenna to be driven with Tx energy and function as a second primary antenna. In some embodiments, such an architecture can enable antenna switch diversity without any dual-pole ASM switch loss penalty, as well as provide the benefit of enabling Tx UL diversity, with either the same signal being driven by two identical or similar Tx RF chains (and associated simultaneous receive functionality) for a true Tx diversity functionality.

It is noted that the original antenna system is typically required to provide low correlation between the primary and diversity antennas. Accordingly, such an antenna system can be utilized for the foregoing UL diversity solution as well. It is also noted that in such a UL diversity solution, the transceiver can be operated with Tx diversity capability without any software or hardware interface/connectivity changes.

In some embodiments, and as described in reference to the examples of FIGS. 4, 8, 8(1)-8(8), 9A, 9A(1)-9A(4), 9B and 9B(1)-9B(4), a front-end solution having one or more features as described herein can be coupled to a transceiver and driven with unique datastreams to provide a UL-MIMO functionality. In some embodiments, each separate dedicated RF drive path from the transceiver can be coupled to a corresponding separate antenna through a separate Tx/Rx-capable module. Accordingly, phase and/or data can be adjusted independently for the RF datastreams, and performance can be optimized for each.

In some embodiments, additional benefits of antenna switch diversity can be attained without penalty of DPnT switch die area and insertion loss performance impact. UL Interband (and even Intra-band Contiguous and Non-Contiguous) carrier aggregation can also make use of the independent Tx signal conditioning in order to leverage antenna isolation to improve the interference performance and relax the RxSensitivity degradation and insertion loss/isolation trade-offs of the front-end to enable these example UL CA scenarios.

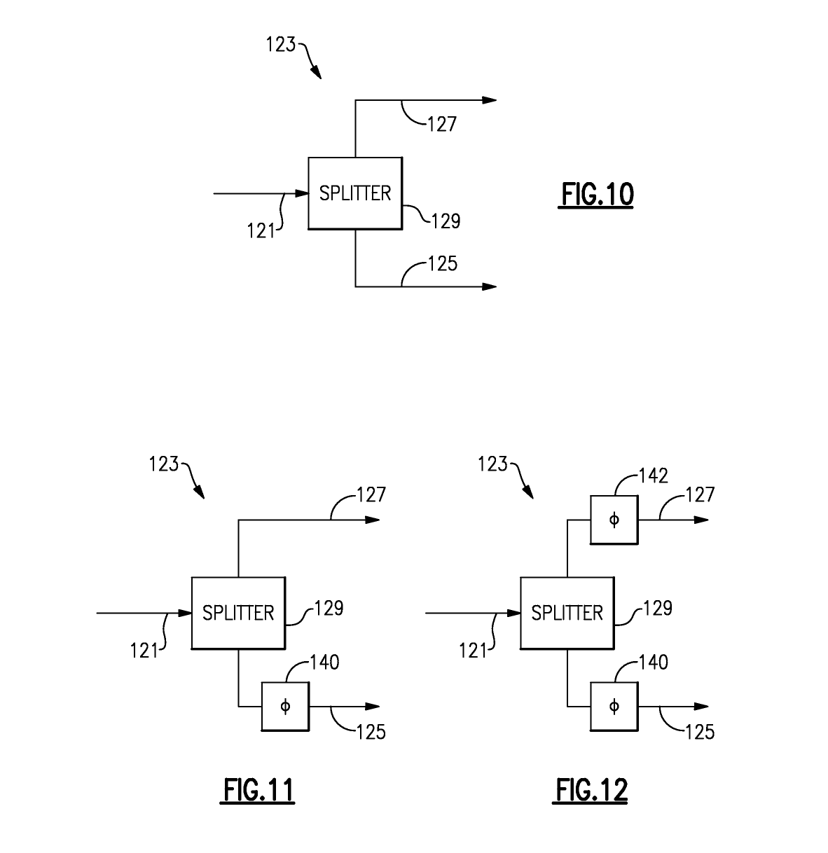

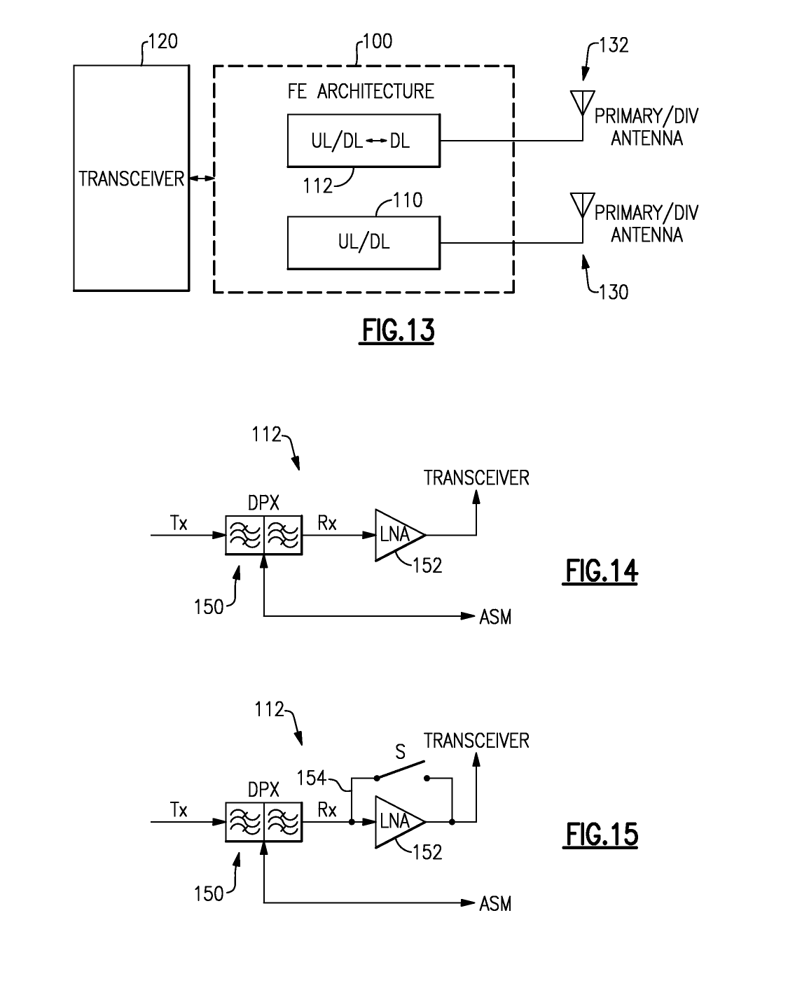

FIG. 13 shows that in some embodiments, an FE architecture 100 such as the example of FIG. 3 can include a second UL/DL module 112 configured to be capable of operating in a DL-only mode. In the example of FIG. 13, the first UL/DL module 110, the first antenna 130, and the coupling between the FE architecture 100 and the transceiver 120 can be similar to the example of FIG. 3.

For the purpose of description, it can be assumed that the second UL/DL module 112 has replaced a DL module. Accordingly, the second UL/DL module 112 can be implemented relative to a second antenna 132 (which, for the DL module, was an Rx diversity antenna). For example, the DL module being positioned relatively close to the Rx diversity antenna can yield a number of advantages for Rx operations, including diversity Rx operations. Further, in some wireless applications involving the FE architecture 100 of FIG. 13, it may be desirable for the second UL/DL module 112 to have the capability to provide the foregoing advantageous Rx operations.

In some embodiments, when the second UL/DL front-end solution is operated only as an Rx-only diversity path, it is preferable that performance degradation relative to a pure Rx-only diversity solution be minimized or reduced. Rx-only diversity paths, such as the example shown in FIGS. 6 and 7, can be configured to only have Rx filters, thereby yielding lower insertion loss than full duplexers of the UL/DL module or full Tx-capable RF path.

In some Rx diversity applications, signal paths can include implementation of LNAs following the Rx diversity filters for noise figure and Rx sensitivity advantage. FIG. 14 shows an example implementation for an Rx path in the UL/DL module 112, where the Rx path can include an LNA 152 after the Rx pin of a duplexer 150. The output of the LNA 152 is shown to be routed to a transceiver.

FIG. 15 shows that in some embodiments, a UL/DL module 112 similar to the example of FIG. 14 can be configured to include a switchable bypass to enable the LNA 152 to be actively in the signal path, or bypassed to avoid the significant challenge of Tx carrier leakage. If the UL/DL module 112 is operating with full power active Tx leakage, then the LNA typically may not be reasonably designed in and still meet the required or desired transceiver IMD2 and reciprocal mixing performance. Accordingly, the LNA 152 can be bypassed. Such an effect can depend on the transceiver linearity, but the option for bypassing can be a desirable feature in some implementations.

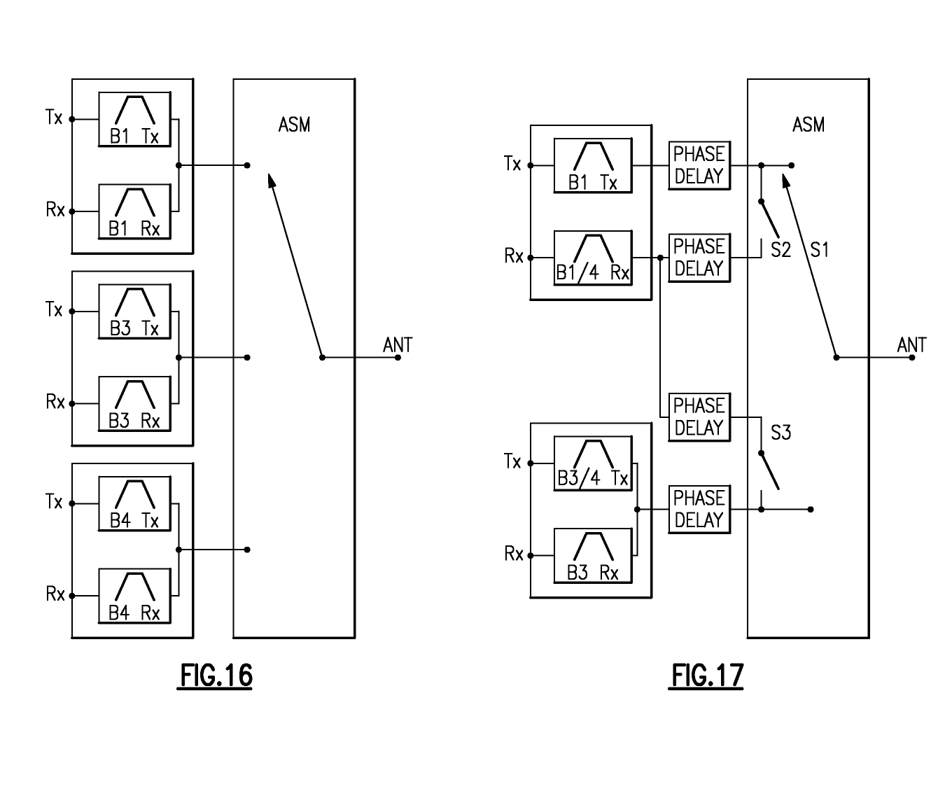

In some embodiments, one or more features of the present disclosure can be implemented in applications where separate Tx and Rx filters are not necessarily ganged together in duplexer pairs, but can be instead separate filters that are switch-combined. For example, FIG. 16 shows an example of a front-end architecture that utilizes a duplexer pair for each of example B1, B3 and B4 bands. FIG. 17 shows an example of a switch-combined filter combination that can provide similar functionality as the example of FIG. 16.

In the example of FIG. 16, an FE architecture is shown to include a routing configuration for the example B1, B3 and B4 bands. Although not shown, it will be understood that other bands can also be implemented in such an architecture. One can see that each band includes a separate duplexer, and each duplexer includes TX and RX filters. Thus, there are six filters shown for the three example bands B1, B3 and B4. The three example duplexers corresponding to the foregoing three bands are shown to be in communication with an antenna port through an antenna switching module (ASM).

FIG. 17 shows that in some embodiments, some or all of circuits and related components associated with the B4 duplexer can be removed, thereby reducing size and cost of the associated module considerably. In the context of the example of FIG. 16, the entire duplexer for B4 can be removed, thereby reducing the number of filters by at least two.

In the example shown in FIG. 17, a first pair of filters is shown to include a B1 TX filter and a B1/4 RX filter that can provide RX filtering functionality for B1 and B4. The B1 TX filter can be connected (e.g., through a phase delay component) to a first switching node (e.g., a first throw) of an antenna switch S1 of an ASM. The B1/4 RX filter can be connected (e.g., through a phase delay component and a switch S2) to the first switching node of the antenna switch S1.

In the example shown in FIG. 17, a second pair of filters is shown to include a B3 RX filter and a B3/4 TX filter that can provide TX filtering functionality for B3 and B4. The B3 RX filter can be connected (e.g., through a phase delay component) to a second switching node (e.g., a second throw) of the antenna switch S1. The B3/4 TX filter can be connected (e.g., through the same phase delay component for B3 RX) to the second switching node of the antenna switch S1.

In the example shown in FIG. 17, the B1/4 RX filter can be connected (e.g., through a phase delay component and a switch S3) to the second switching node of the antenna switch S1. Accordingly, TX and RX operations of B1, B3 and B4 can be effectuated by example switch states listed in Table 1.

TABLE 1

| State | TX | RX | S1 | S2 | S3 |
|---|---|---|---|---|---|
| 1 | B1 | B1 | First throw | 1 | 0 |
| 2 | B3 | B3 | Second throw | 0 | 0 |
| 3 | B4 | B1/B3/B4 | Second throw | 0 | 1 |
| 4 | B1 | B1/B3 | First throw | 1 | 1 |

Additional details related to the examples of FIGS. 16 and 17 can be found in U.S. Patent Application Publication No. 2015/0133067 entitled SYSTEMS AND METHODS RELATED TO CARRIER AGGREGATION FRONT-END MODULE APPLICATIONS, which is expressly incorporated by reference in its entirely, and which is to be considered part of the specification of the present application.

In some embodiments, the foregoing filters can enable a switching configuration that is equivalent to a single path Rx filter and single active ASM throw engaged for low loss (apart from the additional overhead IL of the extra Tx filter switch throws).

FIG. 18 shows that in some embodiments, a by-passable LNA may be implemented for noise figure (NF) advantage. In FIG. 18, the filter assembly and the corresponding switching configuration are similar to the example of FIG. 17.

In the example of FIG. 18, an output of the example B1/4 Rx filter is shown to be connected to an input of an LNA 152 as well as a switchable bypass path 154. Similarly, an output of the example B3 Rx filter is shown to be connected to an input of an LNA 152 as well as a switchable bypass path 154. In some embodiments, the foregoing LNA and bypass configurations can be similar to the example described herein in reference to FIGS. 14 and 15.

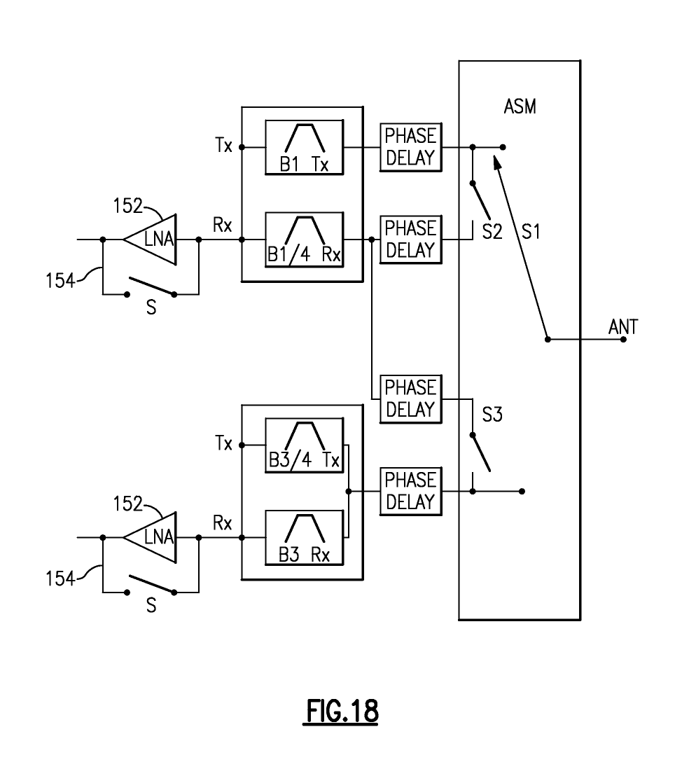

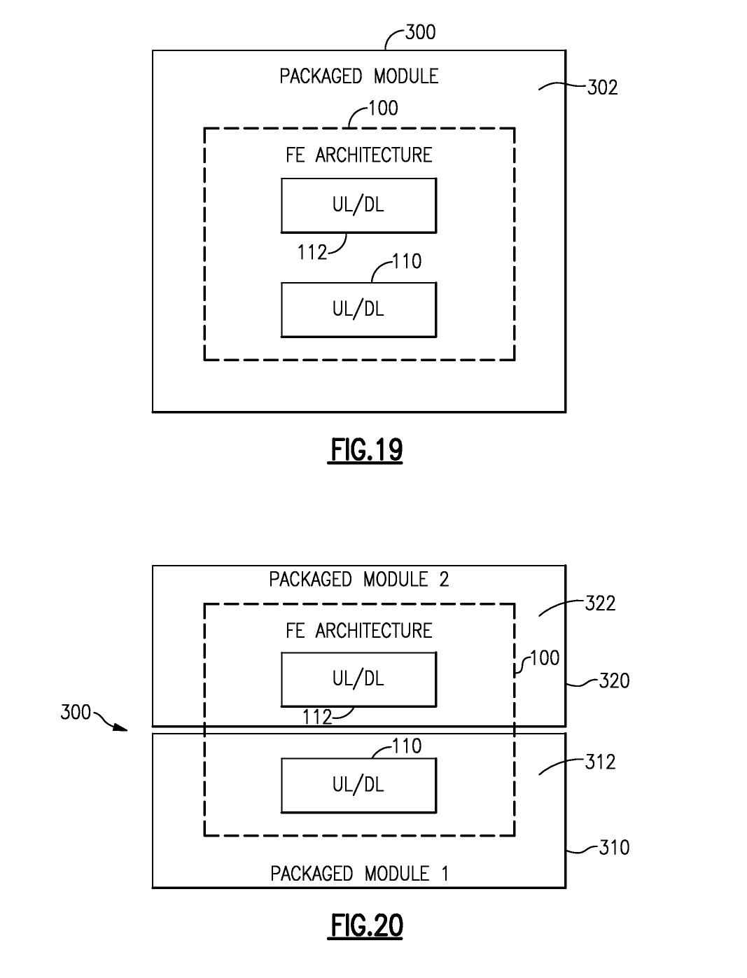

FIGS. 19 and 20 show examples of how an FE architecture having one or more features as described herein can be implemented in one or more packaged modules. FIG. 19 shows that in some embodiments, a packaged module 300 can include some or all of an FE architecture 100, such that both of the first and second UL/DL modules 110, 112 as described herein are implemented as parts of the same packaged module 300. Such a packaged module can include a packaging substrate 302 configured to receive a plurality of components such as the modules 110, 112 and other devices such as surface-mount technology (SMT) devices.

FIG. 20 shows that in some embodiments, a packaged module implementation 300 of an FE architecture 100 having one or more features as described herein can include a separate packaged module for each of the first and second UL/DL modules 110, 112. For example, the first UL/DL module 110 is shown to be part of a first packaged module 310, and the second UL/DL module 120 is shown to be part of a second packaged module 320. Such a configuration can allow, for example, placement of the second packaged module 320 with the second UL/DL module 112 near the corresponding antenna, similar to how a diversity receive module would be implemented. In the example of FIG. 20, each of the two packaged modules 310, 320 can include a corresponding packaging substrate (312 or 322) configured to receive a plurality of components.

In some implementations, an architecture, a device and/or a circuit having one or more features described herein can be included in an RF device such as a wireless device. Such an architecture, a device and/or a circuit can be implemented directly in the wireless device, in one or more modular forms as described herein, or in some combination thereof. In some embodiments, such a wireless device can include, for example, a cellular phone, a smart-phone, a hand-held wireless device with or without phone functionality, a wireless tablet, a wireless router, a wireless access point, a wireless base station, etc.

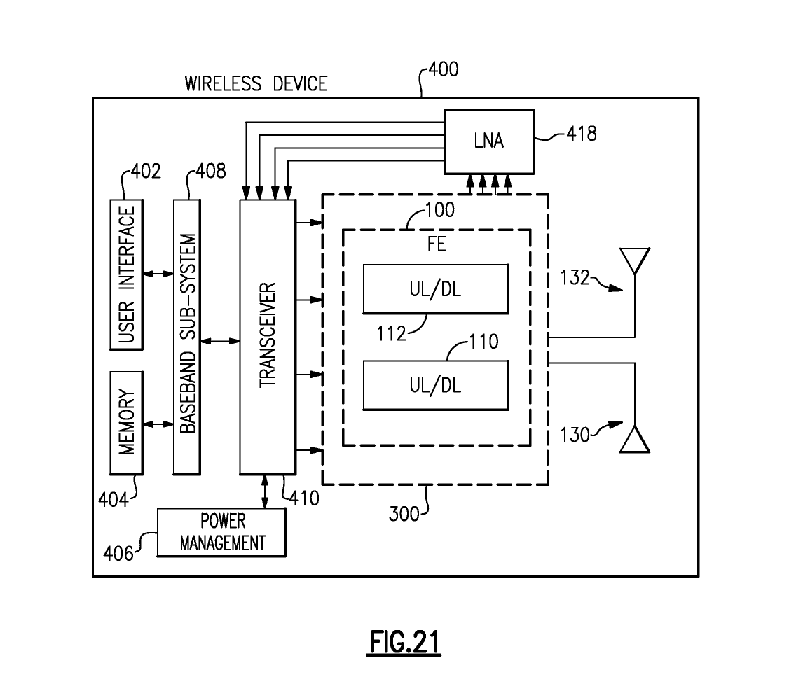

FIG. 21 depicts an example wireless device 400 having one or more advantageous features described herein. In some embodiments, such advantageous features can be implemented in an FE architecture 100 that includes first and second UL/DL modules 110, 112 as described herein. Such an FE architecture can be implemented in one or more packaged modules 300.

Power amplifiers (PAs) (e.g., in the packaged module(s) 300) can receive their respective RF signals from a transceiver 410 that can be configured and operated to generate RF signals to be amplified and transmitted, and to process received signals. The transceiver 410 is shown to interact with a baseband sub-system 408 that is configured to provide conversion between data and/or voice signals suitable for a user and RF signals suitable for the transceiver 410. The transceiver 410 is also shown to be connected to a power management component 406 that is configured to manage power for the operation of the wireless device 400. Such power management can also control operations of the baseband sub-system 408 and other components of the wireless device 400.

The baseband sub-system 408 is shown to be connected to a user interface 402 to facilitate various input and output of voice and/or data provided to and received from the user. The baseband sub-system 408 can also be connected to a memory 404 that is configured to store data and/or instructions to facilitate the operation of the wireless device, and/or to provide storage of information for the user.

In the example wireless device 400, the FE architecture 100 can be configured to be in communication with first and second antennas 130, 132 to provide diversity functionalities for DL operations as well as UL operations. In the example of FIG. 21, one or more low-noise amplifiers (LNAs) 418 may or may not be part of the packaged module(s) 300.

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

One or more features of the present disclosure can be implemented with various cellular frequency bands as described herein. Examples of such bands are listed in Table 2. It will be understood that at least some of the bands can be divided into sub-bands. It will also be understood that one or more features of the present disclosure can be implemented with frequency ranges that do not have designations such as the examples of Table 2.

TABLE 2

| | | Tx Frequency Range | Rx Frequency Range |
|---|---|---|---|
| Band | Mode | (MHz) | (MHz) |
| B1 | FDD | 1,920-1,980 | 2,110-2,170 |
| B2 | FDD | 1,850-1,910 | 1,930-1,990 |
| B3 | FDD | 1,710-1,785 | 1,805-1,880 |
| B4 | FDD | 1,710-1,755 | 2,110-2,155 |
| B5 | FDD | 824-849 | 869-894 |
| B6 | FDD | 830-840 | 875-885 |
| B7 | FDD | 2,500-2,570 | 2,620-2,690 |
| B8 | FDD | 880-915 | 925-960 |
| B9 | FDD | 1,749.9-1,784.9 | 1,844.9-1,879.9 |
| B10 | FDD | 1,710-1,770 | 2,110-2,170 |
| B11 | FDD | 1,427.9-1,447.9 | 1,475.9-1,495.9 |
| B12 | FDD | 699-716 | 729-746 |
| B13 | FDD | 777-787 | 746-756 |
| B14 | FDD | 788-798 | 758-768 |
| B15 | FDD | 1,900-1,920 | 2,600-2,620 |
| B16 | FDD | 2,010-2,025 | 2,585-2,600 |
| B17 | FDD | 704-716 | 734-746 |
| B18 | FDD | 815-830 | 860-875 |
| B19 | FDD | 830-845 | 875-890 |
| B20 | FDD | 832-862 | 791-821 |
| B21 | FDD | 1,447.9-1,462.9 | 1,495.9-1,510.9 |
| B22 | FDD | 3,410-3,490 | 3,510-3,590 |
| B23 | FDD | 2,000-2,020 | 2,180-2,200 |
| B24 | FDD | 1,626.5-1,660.5 | 1,525-1,559 |
| B25 | FDD | 1,850-1,915 | 1,930-1,995 |
| B26 | FDD | 814-849 | 859-894 |
| B27 | FDD | 807-824 | 852-869 |
| B28 | FDD | 703-748 | 758-803 |
| B29 | FDD | N/A | 716-728 |
| B30 | FDD | 2,305-2,315 | 2,350-2,360 |
| B31 | FDD | 452.5-457.5 | 462.5-467.5 |
| B33 | TDD | 1,900-1,920 | 1,900-1,920 |
| B34 | TDD | 2,010-2,025 | 2,010-2,025 |
| B35 | TDD | 1,850-1,910 | 1,850-1,910 |
| B36 | TDD | 1,930-1,990 | 1,930-1,990 |
| B37 | TDD | 1,910-1,930 | 1,910-1,930 |
| B38 | TDD | 2,570-2,620 | 2,570-2,620 |
| B39 | TDD | 1,880-1,920 | 1,880-1,920 |
| B40 | TDD | 2,300-2,400 | 2,300-2,400 |
| B41 | TDD | 2,496-2,690 | 2,496-2,690 |
| B42 | TDD | 3,400-3,600 | 3,400-3,600 |
| B43 | TDD | 3,600-3,800 | 3,600-3,800 |
| B44 | TDD | 703-803 | 703-803 |

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A radio-frequency (RF) front-end architecture comprising:
a first transmit/receive (Tx/Rx) front-end system configured to operate with a first antenna; and
a second Tx/Rx front-end system configured to operate with a second antenna.

2. The RF front-end architecture of claim 1 wherein each of the first antenna and the second antenna is capable of operating as a primary antenna.

3. The RF front-end architecture of claim 2 wherein the second antenna is an Rx diversity antenna capable of operating as a Tx diversity antenna.

4. The RF front-end architecture of claim 1 wherein the RF front-end architecture is configured to receive a common Tx signal from a transceiver and split the common Tx signal to each of the first and second Tx/Rx front-end systems to provide Tx diversity functionality.

5. The RF front-end architecture of claim 4 further including a splitter configured to split the common Tx signal into first and second signal paths for the first and second Tx/Rx front-end systems, respectively.

6. The RF front-end architecture of claim 5 wherein each of either or both of the first and second signal paths includes a phase-shifting circuit.

7. The RF front-end architecture of claim 1 wherein the RF front-end architecture is configured to receive a separate Tx signal from a transceiver for each of the first and second Tx/Rx front-end systems.

8. The RF front-end architecture of claim 7 wherein the separate Tx signals from the transceiver include respective dedicated datastreams such that the RF front-end architecture provides an uplink (UL) multiple-input-and-multiple-output (MIMO) functionality.

9. The RF front-end architecture of claim 1 wherein at least one of the first and second Tx/Rx front-end systems is configured to be capable of operating in an Rx-only mode.

10. The RF front-end architecture of claim 9 wherein the Tx/Rx system with the Rx-only mode capability includes a low-noise amplifier (LNA) coupled to an output of an Rx filter.

11. The RF front-end architecture of claim 10 wherein the Tx/Rx system with the Rx-only mode capability further includes a switchable path implemented to allow bypassing of the LNA.

12. The RF front-end architecture of claim 1 wherein at least one of the first and second Tx/Rx front-end systems includes a plurality of switch-combined filters configured to provide one or more duplexing functionalities.

13. The RF front-end architecture of claim 1 wherein the second Tx/Rx front-end system is a substantial duplicate of the first Tx/Rx front-end system.

14. The RF front-end architecture of claim 13 wherein the first Tx/Rx front-end system is implemented in a first uplink (UL)/downlink (DL) module and the second Tx/Rx front-end system is implemented in a second UL/DL module.

15. The RF front-end architecture of claim 13 wherein the first UL/DL module is part of a first packaged module, and the second UL/DL module is part of a second packaged module.

16. A method for performing diversity operations with radio-frequency (RF) signals, the method comprising:
processing transmit (Tx) and receive (Rx) signals with a first Tx/Rx front-end system and a first antenna; and
processing Tx and Rx signals with a second Tx/Rx front-end system and a second antenna to provide Tx diversity and Rx diversity through the first and second antennas.

17. A wireless device comprising:
a transceiver configured to process RF signals; and
a front-end (FE) architecture in communication with the transceiver, the FE architecture including a first transmit/receive (Tx/Rx) front-end system configured to operate with a first antenna, and a second Tx/Rx front-end system configured to operate with a second antenna.

18. The wireless device of claim 17 wherein the wireless device is a cellular phone.

19. The wireless device of claim 17 wherein the communication between the transceiver and the FE architecture includes a common Tx signal that is split into each of the first and second Tx/Rx front-end systems to provide Tx diversity through the first and second antennas.

20. The wireless device of claim 17 wherein the communication between the transceiver and the FE architecture includes a separate Tx signal for each of the first and second Tx/Rx front-end systems to provide an uplink (UL) multiple-input-and-multiple-output (MIMO) functionality for the FE architecture.
